(19) United States
(12) Patent Application Publication
(10) Pub. No.: US 2021/0012091 A1
(43) Pub. Date: Jan. 14, 2021

(54) METHOD AND APPARATUS FOR IMAGE PROCESSING, ELECTRONIC DEVICE, AND STORAGE MEDIUM

(71) Applicant: BEIJING SENSETIME TECHNOLOGY DEVELOPMENT CO., LTD., Beijing (CN)

(72) Inventors: Tinghao LIU, Beijing (CN); Quan WANG, Beijing (CN); Chen QIAN, Beijing (CN)

(21) Appl. No.: 16/977,204

(22) PCT Filed: May 23, 2019
(86) PCT No.: PCT/CN2019/088185

§ 371 Date: Sep. 1, 2020

(30) Foreign Application Priority Data
Jul. 11, 2018 (CN) 201810757714.5

(51) Int. Cl. G06K 9/00; G06F 21/31; G06Q 20/40

(52) U.S. Cl. CPC G06K 9/00255; G06K 9/00288; G06Q 20/401; G06K 9/00906; G06F 21/31; G06K 9/00281

(57) ABSTRACT

Embodiments of the present disclosure relate to a method and an apparatus for image processing, an electronic device and a storage medium. The method includes: obtaining a target region image in an image to be identified, the target region image comprising at least one target object; determining a state of each of the at least one target object based on the target region image, where the state includes an opened-eye state and a closed-eye state; and determining an identity authentication result based at least part on the state of each of the at least one target object.

### CROSS-REFERENCE TO RELATED APPLICATION

The disclosure is filed based upon and claims priority to Chinese patent application No. 201810757714.5, filed on July 11, 2018, the disclosure of which is hereby incorporated by reference in its entirety.

### TECHNICAL FIELD

The disclosure relates to the technical field of computer vision, and more particularly to a method and an apparatus for image processing, an electronic device, and a storage medium.

### BACKGROUND

Along with the rapid development of Internet technologies, computer-vision-based image processing technologies have experienced unprecedented development and been applied to various fields. For example, face recognition technologies are extensively applied to scenarios such as identity authentication. However, the security of face-image-based identity authentication needs to be further improved.

### SUMMARY

In view of this, embodiments of the disclosure provide an image processing technical solution.

According to an aspect of the embodiments of the disclosure, a method for image processing is provided, which includes the following operations. A target region image may be acquired, the target region image including at least one target object. A state of each of the at least one target object may be determined based on the target region image, the state including eye-open and eye-closed. An identity authentication result may be determined based at least part on the state of each of the at least one target object.

In some embodiments, it may be determined that the state of each of the target object may be eye-open or eye-closed, and the identity authentication result may be determined at least partially based on the state of each of the at least one target object.

In some embodiments, recognition processing may be performed on the target region image to obtain the state of each of the at least one target object. For example, recognition processing may be performed on the target region image by use of a state recognition neural network to obtain state information of each of the at least one target object, the state information being configured to indicate the state of each of the at least one target object. For example, the state information may include an eye-open confidence or eye-closed confidence, or may include an identifier or indicator indicating the state.

In some embodiments, the at least one target object may include at least one eye.

In some embodiments, the at least one target object may include two eyes, and correspondingly, the target region image may be a region image including two eyes. For example, the target region image may be a face image or two region images of which each includes an eye, i.e., a left-eye region image and a right-eye region image.

In some embodiments, feature extraction processing may be performed on the target region image to obtain feature information of the target region image, and the state of each of the at least one target object in the target region image may be determined based on the feature information of the target region image.

In some embodiments, the operation that the identity authentication result is determined based at least part on the state of each of the at least one target object may include the following operation. Responsive to the at least one target object including a target object of which a state is eye-open, it may be determined that identity authentication succeeds.

In some embodiments, it may be determined that identity authentication succeeds at least partially responsive to the state of each of at least one target object being eye-open. For example, there is made such a hypothesis that the at least one target object is two target objects, and in such case, responsive to that a state of one target object is eye-open and a state of the other target object is eye-closed, or responsive to the state of each of the two target objects is eye-open, it may be determined that identity authentication succeeds.

In some embodiments, face recognition may be performed based on a face image of a person corresponding to the target region image responsive to the at least one target object including the target object of which the state is eye-open. The identity authentication result may be determined based on a face recognition result. For example, it may be determined that identity authentication succeeds responsive to the face recognition result being that recognition succeeds, and it may be determined that identity authentication fails responsive to the face recognition result being that recognition fails.

In some other embodiments, it may be determined that identity authentication succeeds only responsive to the state of each of the at least one target object is eye-open, or, it may be determined that identity authentication succeeds only under the condition that the state of each of the at least one target object is eye-open. In such case, if the at least one target object includes a target object of which the state is eye-closed, it may be determined that identity authentication fails.

In some embodiments, before the operation that the state of each of the at least one target object is determined based on the target region image, the method may further include the following operation. Whether there is preset image information in a base database matched with an image to be recognized corresponding to the target region image is determined. The operation that the state of each of the at least one target object is determined based on the target region image may include the following operation. Responsive to there being the preset image information in the base database matched with the image to be recognized, the state of each of the at least one target object may be determined. In some embodiments, the image to be recognized may be a face image or a human body image.

In some embodiments, the method may further include that the following operation. Face recognition may be performed on the image to be recognized to obtain a face recognition result.

The operation that the identity authentication result is determined based at least part on the state of each of the at least one target object may include the following operation. The identity authentication result is determined based at least part on the face recognition result and the state of each of the at least one target object.

In an example, responsive to the face recognition result being that recognition succeeds and the at least one target object including the target object of which the state is eye-open, it may be determined that identity authentication succeeds.

In another example, responsive to the face recognition result being that recognition fails or the state of each of the at least one target object is eye-closed, it may be determined that identity authentication fails.

In some embodiments, the method may further include the following operations. Liveness detection may be performed on the image to be recognized to determine a liveness detection result. The operation that the identity authentication result may be determined based at least part on the face recognition result and the state of each of the at least one target object may include the following operation. The identity authentication result may be determined based on the face recognition result, the liveness detection result and the state of each of the at least one target object.

In an example, responsive to the face recognition result being that recognition succeeds, the liveness detection result may indicate a living body and the at least one target object may include the target object of which the state is eye-open, it may be determined that identity authentication succeeds.

In another example, responsive to the face recognition result being that recognition fails, or the liveness detection result indicating a non-living body or the state of each of the at least one target object is eye-closed, it may be determined that identity authentication fails.

In some embodiments, the operation that the identity authentication result may be determined based at least part on the state of each of the at least one target object may include the following operations. Responsive to the at least one target object including the target object of which the state is eye-open, face recognition may be performed on the image to be recognized to obtain the face recognition result. The identity authentication result may be determined based on the face recognition result.

In some embodiments, the state of each of the at least one target object may be determined after face recognition of the image to be recognized succeeds, or, face recognition of the image to be recognition and determination of the state of each of the at least one target object may be executed at the same time, or, face recognition may be executed on the image to be recognized after the state of each of the at least one target object is determined.

In some embodiments, whether there is reference image information in the base database matched with the image to be recognized may be determined, and responsive to determining that there is the reference image information in the base database matched with the image to be recognized, it may be determined that face recognition succeeds. For example, preset image information in the base database may include preset image feature information, and whether there is the preset image information in the base database matched with the image to be recognized may be determined based on a similarity between feature information of the image to be recognized and at least one piece of preset image feature information.

In some embodiments, the operation that the target region image is acquired may include the following operation. The target region image in the image to be recognized may be acquired according to key point information corresponding to each of the at least one target object.

In some embodiments, the target region image may include a first region image and a second region image, and the at least one target object may include a first target object and a second target object. The operation that the target region image in the image to be recognized is acquired may include the following operations. The first region image in the image to be recognized may be acquired, the first region image including the first target object. Mirroring processing may be performed on the first region image to obtain the second region image, the second region image including the second target object.

In some embodiments, the operation that the state of each of the at least one target object is determined based on the target region image may include that the following operations. The target region image may be processed to obtain a prediction result, the prediction result including at least one of image validity information of the target region image or state information of the at least one target object. The state of each of the at least one target object may be determined according to at least one of the image validity information or the state information of the at least one target object.

In some embodiments, the image validity information of the target region image may be determined based on the feature information of the target region image, and the state of each of the at least one target object may be determined based on the image validity information of the target region image.

In an example, the target region image may be processed by use of the neural network to output the prediction result.

In some embodiments, the image validity information may indicate whether the target region image is valid.

In some embodiments, the operation that the state of each of the at least one target object is determined according to at least one of the image validity information or the state information of the at least one target object may include the following operation. Responsive to the image validity information indicating that the target region image is invalid, it may be determined that the state of each of the at least one target object is eye-closed.

In an example, responsive to the image validity information indicating that the target region image is invalid, it may be determined that the state of each of the at least one target object is eye-closed.

In some embodiments, the operation that the state of each of the at least one target object is determined according to at least one of the image validity information or the state information of the at least one target object may include the following operation. Responsive to the image validity information indicating that the target region image is valid, the state of each of the at least one target object may be determined based on the state information of each of the at least one target object.

In some embodiments, the image validity information may include a validity confidence, and the state information may include the eye-open confidence or the eye-closed confidence.

In an example, responsive to the validity confidence exceeding a first threshold and the eye-open confidence of the target object exceeding a second threshold, it may be determined that the state of the target object is eye-open.

In another example, responsive to that the validity confidence is lower than the first threshold, or the eye-open confidence of a certain target object is lower than the second threshold, it may be determined that the state of the target object is eye-closed.

In some embodiments, the operation that the target region image is processed to obtain the prediction result may include the following operations. Feature extraction processing may be performed on the target region image to obtain feature information of the target region image. The prediction result may be obtained according to the feature information of the target region image.

In some embodiments, the operation that feature extraction processing is performed on the target region image to obtain the feature information of the target region image may include the following operation. Feature extraction processing may be performed on the target region image by use of a deep Residual Network (ResNet) to obtain the feature information of the target region image.

In some embodiments, the method may further include the following operation. Responsive to determining that identity authentication succeeds, a terminal device may be unlocked. In some embodiments, the method may further the following operation. Responsive to determining that identity authentication succeeds, a payment operation may be executed.

In some embodiments, the operation that the state of each of the at least one target object is determined based on the target region image may include the following operation. The target region image is processed by use of an image processing network to obtain the state of each of the at least one target object. The method may further include the following operation. The image processing network may be trained according to multiple sample images.

In some embodiments, the operation that the image processing network is trained according to the multiple sample images may include the following operations. The multiple sample images may be preprocessed to obtain multiple preprocessed sample images. The image processing network may be trained according to the multiple preprocessed sample images.

In some embodiments, the operation that the image processing network is trained according to the multiple sample images may include the following operations. The sample image may be input to the image processing network for processing to obtain a prediction result corresponding to the sample image. Model loss of the image processing network may be determined according to the prediction result and labeling information corresponding to the sample image. A network parameter value of the image processing network may be regulated according to the model loss.

In some embodiments, the method may further include the following operations. Multiple initial sample images and labeling information of the multiple initial sample images may be acquired. Conversion processing may be performed on at least one initial sample image in the multiple initial sample images to obtain at least one extended sample image, conversion processing including at least one of occluding, image exposure changing, image contrast changing or transparentizing processing. Labeling information of the at least one extended sample image may be obtained based on conversion processing executed on the at least one initial sample image and the labeling information of the at least one initial sample image, the multiple sample images including the multiple initial sample images and the at least one extended sample image.

In some embodiments, the method may further include the following operations. A test sample may be processed by use of the image processing network to obtain a prediction result of the test sample. Threshold parameters of the image processing network may be determined based on the prediction result of the test sample and labeling information of the test sample.

In some embodiments, the method may further include the following operations.

The multiple initial sample images and the labeling information of the multiple initial sample images may be acquired. Conversion processing may be performed on the at least one initial sample image in the multiple initial sample images to obtain the at least one extended sample image, conversion processing including at least one of occluding, image exposure changing, image contrast changing or transparentizing processing. The labeling information of the at least one extended sample image may be obtained based on conversion processing executed on the at least one initial sample image and the labeling information of the at least one initial sample image. The image processing network may be trained based on a training sample set including the multiple initial sample images and the at least one extended sample image.

According to an aspect of the embodiments of the disclosure, a method for image processing is provided, which may include the following operations. A target region image in an image to be recognized may be acquired, the target region image including at least one target object. Feature extraction processing may be performed on the target region image to obtain feature information of the target region image. A state of each of the at least one target object may be determined according to the feature information of the target region image, the state including eye-open and eye-closed.

In some embodiments, the operation that the target region image in the image to be recognized is acquired may include the following operation.

The target region image in the image to be recognized may be acquired according to key point information corresponding to each of the at least one target object.

In some embodiments, the target region image may include a first region image and a second region image, and the at least one target object may include a first target object and a second target object.

The operation that the target region image in the image to be recognized is acquired may include the following operations. The first region image in the image to be recognized may be acquired, the first region image including the first target object. Mirroring processing may be performed on the first region image to obtain the second region image, the second region image including the second target object.

In some embodiments, the operation that the state of each of the at least one target object is determined according to the feature information of the target region image may include the following operations. A prediction result may be obtained according to the feature information of the target region image, the prediction result including at least one of image validity information of the target region image or state information of the at least one target object. The state of each of the at least one target object may be determined according to at least one of the image validity information or the state information of the at least one target object.

In some embodiments, the operation that the state of each of the at least one target object is determined according to at least one of the image validity information or the state information of the at least one target object may include the following operation. Responsive to the image validity information indicating that the target region image is invalid, it may be determined that the state of each of the at least one target object is eye-closed.

In some embodiments, the operation that the state of each of the at least one target object is determined according to at least one of the image validity information or the state information of the at least one target object may include the following operation. Responsive to that the image validity information indicating that the target region image is valid, the state of each of the at least one target object may be determined based on the state information of each of the at least one target object.

In some embodiments, the image validity information may include a validity confidence, and the state information may include an eye-open confidence. The operation that the state of each of the at least one target object is determined according to at least one of the image validity information or the state information of the at least one target object may include the following operation. Responsive to the validity confidence exceeding a first threshold and the eye-open confidence of the target object exceeding a second threshold, it may be determined that the state of the target object is eye-open.

In some embodiments, the operation that feature extraction processing is performed on the target region image to obtain the feature information of the target region image may include the following operation. Feature extraction processing may be performed on the target region image by use of a deep ResNet to obtain the feature information of the target region image.

According to an aspect of the embodiments of the disclosure, an apparatus for image processing is provided, which may include an image acquisition module, a state determination module and an authentication result determination module.

The image acquisition module may be configured to acquire A target region image in an image to be recognized, the target region image including at least one target object. The state determination module may be configured to determine a state of each of the at least one target object based on the target region image, the state including eye-open and eye-closed. The authentication result determination module may be configured to determine an identity authentication result based at least part on the state of each of the at least one target object.

According to an aspect of the embodiments of the disclosure, an apparatus for image processing is provided, which may include a target region image acquisition module, an information acquisition module and a determination module. The target region image acquisition module may be configured to acquire one or more target region images in an image to be recognized, the target region image including at least one target object. The information acquisition module may be configured to perform feature extraction processing on the target region image to obtain feature information of the target region image. The determination module may be configured to determine a state of each of the at least one target object according to the feature information of the target region image, the state including eye-open and eye-closed.

According to an aspect of the embodiments of the disclosure, an electronic device is provided, which may include a processor and a memory. The memory may be configured to store instructions executable for the processor, the processor being configured to execute the above mentioned method for image processing or any possible embodiment of the method for image processing.

According to an aspect of the embodiments of the disclosure, a computer-readable storage medium is provided, in which computer program instructions may be stored, the computer program instructions being executed by a processor to implement the above mentioned method for image processing or any possible embodiment of the method for image processing.

In the embodiments of the disclosure, A target region image in the image to be recognized may be acquired, the state of each of the at least one target object in the target region image may be determined, and the identity authentication result may be determined based at least part on the state of each of the at least one target object, so that improvement of the identity authentication security is facilitated.

According to the following detailed descriptions made to exemplary embodiments with reference to the drawings, other features and aspects of the disclosure may become clear.

### BRIEF DESCRIPTION OF THE DRAWINGS

The drawings included in the specification and forming a part of the specification, together with the specification, show the exemplary embodiments, features and aspects of the disclosure and are adopted to explain the principle of the disclosure.

FIG. 1 is a flowchart of a method for image processing according to embodiments of the disclosure.

FIG. 2 is another flowchart of a method for image processing according to embodiments of the disclosure.

FIG. 3 is another flowchart of a method for image processing according to embodiments of the disclosure.

FIG. 4 is another flowchart of a method for image processing according to embodiments of the disclosure.

FIG. 5 is a schematic diagram of an image processing network configured to implement an image processing method according to embodiments of the disclosure.

FIG. 6 is another flowchart of a method for image processing according to embodiments of the disclosure.

FIG. 7 is a flowchart of a training method for an image processing network according to embodiments of the disclosure.

FIG. 8 is another flowchart of a training method for an image processing network according to embodiments of the disclosure.

FIG. 9 is another flowchart of an image processing method according to embodiments of the disclosure.

FIG. 10 is another flowchart of an image processing method according to embodiments of the disclosure.

FIG. 11 is another flowchart of a method for image processing according to embodiments of the disclosure.

FIG. 12 is another flowchart of a method for image processing according to embodiments of the disclosure.

FIG. 13 is another flowchart of a method for image processing according to embodiments of the disclosure.

FIG. 14 is another flowchart of a method for image processing according to embodiments of the disclosure.

FIG. 15 is another flowchart of a method for image processing according to embodiments of the disclosure.

FIG. 16 is another flowchart of a method for image processing according to embodiments of the disclosure.

FIG. 17 is a flowchart of another method for image processing according to embodiments of the disclosure.

FIG. 18 is another flowchart of another method for image processing according to embodiments of the disclosure.

FIG. 19 is another flowchart of another method for image processing according to embodiments of the disclosure.

FIG. 20 is another flowchart of another method for image processing according to embodiments of the disclosure.

FIG. 21 is another flowchart of another method for image processing according to embodiments of the disclosure.

FIG. 22 is an exemplary block diagram of an apparatus for image processing according to embodiments of the disclosure.

FIG. 23 is another exemplary block diagram of an apparatus for image processing according to embodiments of the disclosure.

FIG. 24 is an exemplary block diagram of another apparatus for image processing according to embodiments of the disclosure.

FIG. 25 is another exemplary block diagram of another apparatus for image processing according to embodiments of the disclosure.

FIG. 26 is an exemplary block diagram of an electronic device according to embodiments of the disclosure.

FIG. 27 is another exemplary block diagram of an electronic device according to embodiments of the disclosure.

### DETAILED DESCRIPTION

Each exemplary embodiment, feature and aspect of the disclosure will be described below with reference to the drawings in detail. The same reference signs in the drawings represent components with the same or similar functions. Although each aspect of the embodiments is shown in the drawings, the drawings are not required to be drawn to scale, unless otherwise specified. Herein, special term “exemplary” refers to “use as an example, embodiment or description”. Herein, any “exemplarily” described embodiment may not be explained to be superior to or better than other embodiments. In addition, for describing the disclosure better, many specific details are presented in the following specific implementation modes. It is understood by those skilled in the art that the disclosure may still be implemented even without some specific details. In some examples, methods, means, components and circuits known very well to those skilled in the art are not described in detail, to highlight the subject of the disclosure.

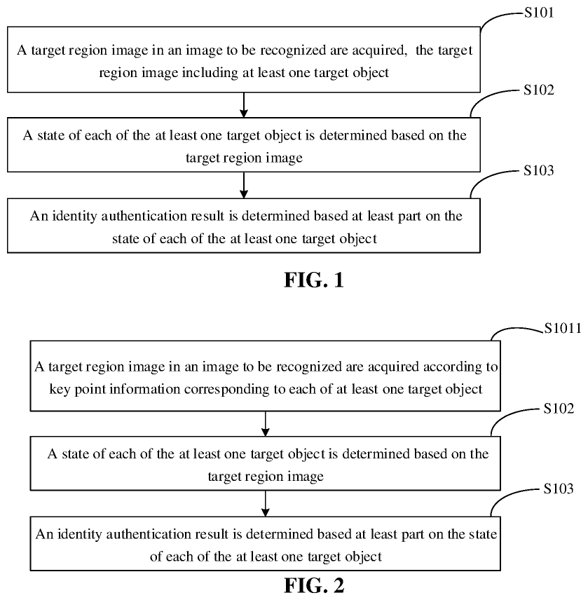

FIG. 1 is a flowchart of a method for image processing according to embodiments of the disclosure. The method may be applied to an electronic device or a system. The electronic device may be provided as a terminal, a server or a device of another form, for example, a mobile phone, a tablet computer, and the like. As shown in FIG. 1, the method includes the following operations.

In S101, A target region image in an image to be recognized is acquired, the target region image including at least one target object.

In S102, a state of each of the at least one target object is determined based on the target region image, the state including eye-open and eye-closed.

In S103, an identity authentication result is determined based at least part on the state of each of the at least one target object.

According to the embodiments of the disclosure, the target region image in the image to be recognized may be acquired, the state of each of the at least one target object in the target region image may be determined, and the identity authentication result may be determined based at least part on the state of each of the at least one target object. In such a manner, whether an identity authentication process is known to a present user may be determined based at least part on the state of each of the at least one target object, so that improvement of the identity authentication security is facilitated. For example, it may be determined that the state of the target object is eye-open or eye-closed, and the identity authentication result may be determined at least partially based on the state of each of the at least one target object.

In some embodiments, recognition processing may be performed on the target region image to obtain the state of each of the at least one target object. For example, recognition processing may be performed on the target region image by use of a state recognition neural network to obtain state information of each of the at least one target object, the state information being configured to indicate the state of each of the at least one target object. The state recognition neural network may be trained according to a training sample set. For example, the state information may include an eye-open confidence or an eye-closed confidence, or may include an identifier indicating the state or an indicator indicating the state. A manner for determining the state information of each of the at least one target object, an information content and type of the state information and the like are not limited in the embodiment of the disclosure.

In some embodiments, the at least one target object includes at least one eye. In some embodiments, the at least one target object may include two eyes, and correspondingly, the target region image may be a region image including two eyes. For example, the target region image may be a face image or two region images of which each includes an eye, i.e., a left-eye region image and a right-eye region image. No limits are made thereto in the embodiment of the disclosure.

In some embodiments, feature extraction processing may be performed on the target region image to obtain feature information of the target region image, and the state of each of the at least one target object in the target region image may be determined based on the feature information of the target region image.

In an exemplary application scenario, in an identity authentication process, the electronic device (for example, a mobile phone of the user) may acquire a face image currently to be recognized or an image of a region nearby an eye in a human body image and then make an eye opening/closing judgment according to the image of the region nearby the eye to determine whether a state of each of at least one eye is open or closed. The mobile phone of the user may determine an identity authentication result based on the state of each of the at least one eye. For example, the mobile phone of the user may judge whether the present user knows present identity authentication according to an eye state result obtained by the eye opening/closing judgment. If the user knows present identity authentication, the identity authentication result indicating, for example, identity authentication succeeds or identity authentication fails, may be determined based on that the user knows present identity authentication. If the user does not know present identity authentication, the identity authentication result indicating, for example, identity authentication fails, may be determined based on that the user does not know present identity authentication. Therefore, the probability of occurrence of the condition that another person passes identity authentication in a manner of shooting the face image of the user and the like when the user knows nothing (for example, the user sleeps, the user is in a coma, or various conditions that cause the user knows nothing) may be reduced, and the identity authentication security is improved.

In some embodiments, the electronic device may be any device such as a mobile phone, a pad, a computer, a server and the like. Descriptions are now made with the condition that the electronic device is a mobile phone as an example. For example, the mobile phone of the user may acquire a the target region image in the image to be recognized, the target region image including the at least one target object. The image to be recognized may be a real image, and for example, may be an original image or an image obtained by processing. No limits are made thereto in the embodiment of the disclosure. The target region image may be an image of a certain region in the image to be recognized, and for example, may be an image nearby the at least one target object in the image to be recognized. For example, the image to be recognized may be a face image, the at least one target object may include at least one eye, and the target region image may be an image nearby the at least one eye in the face image. It is to be understood that the target region image in the image to be recognized may be acquired in multiple manners and no limits are made thereto in the embodiment of the disclosure.

FIG. 2 is another flowchart of a method for image processing according to embodiments of the disclosure. In some embodiments, as shown in FIG. 2, S101 may include the following operation.

In S1011, the target region image in the image to be recognized is acquired according to key point information corresponding to each of the at least one target object.

For example, a key point positioning network configured to position face key points may be trained by deep learning (for example, the key point positioning network may include a convolutional neural network). The key point positioning network may determine the key point information corresponding to each of the at least one target object in the image to be recognized to determine a region where each of the at least one target object is located. For example, the key point positioning network may determine key point information of each of the at least one eye in the image to be recognized (for example, the face image) and determine a position of contour points of the at least one eye. Based on this, the image(s) nearby the at least one eye may be captured in a well-known manner in the related art. For example, image processing may be performed according to the position, determined by the key point positioning network, of the contour points of the at least one eye to capture a rectangular image as the image nearby the at least one eye, thereby obtaining the image (the target region image) nearby the at least one eye in the image to be recognized (for example, the face image). In such a manner, the target region image is acquired according to the key point information corresponding to each of the at least one target object, so that the target region image may be acquired rapidly and accurately, the target region image including the at least one target object. A manner for determining the key point information corresponding to each of the at least one target object and a manner for acquiring the target region image in the image to be recognized according to the key point information are not limited in the embodiment of the disclosure.

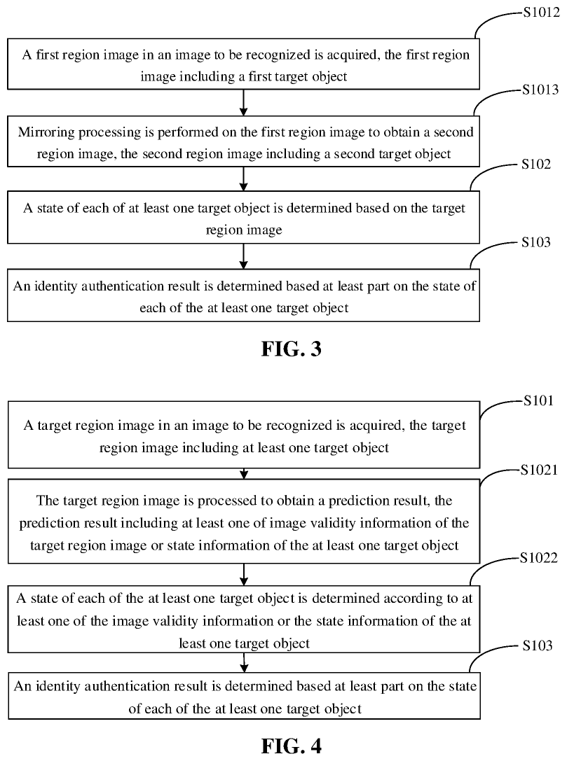

FIG. 3 is another flowchart of a method for image processing according to embodiments of the disclosure. In some embodiments, the target region image includes a first region image and a second region image, and the at least one target object includes a first target object and a second target object. As shown in FIG. 3, S101 may include the following operations.

In S1012, the first region image in the image to be recognized is acquired, the first region image including the first target object.

In S1013, mirroring processing is performed on the first region image to obtain the second region image, the second region image including the second target object.

For example, the target region image may include two target objects, i.e., the first target object and the second target object respectively. For example, the face image includes a right eye (for example, the first target object) and a left eye (for example, the second target object). The target region image may also include the first region image (for example, a region including the first target object) and the second region image (for example, a region including the second target object).

In the process of acquiring the target region image in the image to be recognized (S101), the first region image and the second region image may be acquired respectively. For example, the first region image in the image to be recognized may be acquired, the first region image including the first target object. For example, as mentioned above, the first region image in the image to be recognized may be acquired according to the key point information corresponding to the first target object.

In some embodiments, the second region image may be acquired based on the acquired first region image in the image to be recognized. For example, mirroring processing may be performed on the first region image to obtain the second region image, the second region image including the second target object. For example, an image nearby the right eye in the face image may be acquired (for example, the first region image is a rectangular image). It is to be understood that the left eye and right eye in the face image are symmetric. Mirroring processing may be performed on the rectangular image to acquire an image (for example, the second region image the same as the first region image in shape and size) nearby the left eye in the face image. Therefore, the first region image and second region image in the target region image may be acquired relatively rapidly. It is to be understood that, when the target region image includes the first region image and the second region image, the operation that the target region image in the image to be recognized is acquired may also be implemented in a manner that the first region image and the second region image are acquired according to the key point information corresponding to the first target object and the key point information corresponding to the second target object respectively. The manner for acquiring the target region image in the image to be recognized, the number of region images comprised in the target region image and the like are not limited in the embodiment of the disclosure.

As shown in FIG. 1, in S102, the state of each of the at least one target object is determined based on the target region image, the state including eye-open and eye-closed.

For example, the eye opening/closing judgment may be judged according to the target region image to determine whether the state of each of the at least one eye in the target region image is open or closed. For example, the target region image includes the first region image and the second region image, the first region image includes the right eye, and the second region image includes the left eye. The mobile phone of the user, when acquiring the target region image (including the first region image and the second region image), may determine whether state of each of the right eye and the left eye is open or closed based on the first region image and the second region image respectively. It is to be understood that the state of each of the at least one target object may be determined based on the target region image in multiple manners and no limits are made thereto in the embodiment of the disclosure.

FIG. 4 is another flowchart of a method for image processing according to embodiments of the disclosure. In some embodiments, as shown in FIG. 4, S102 may include the following operation.

In S1021, the target region image is processed to obtain a prediction result, the prediction result including at least one of image validity information of the target region image or state information of the at least one target object.

In an example, the target region image may be processed by use of the neural network to output the prediction result.

The image validity information may be configured to represent a validity condition of the target region image. For example, the image validity information may indicate whether the target region image is valid, and for example, may be configured to indicate that the target region image is valid or invalid. The state information of the target object may be configured to represent that the state of the target object is eye-open or eye-closed. At least one of the image validity information of the target region image or the state information of the at least one target object may be configured to determine the state of each of the at least one target object. For example, the mobile phone of the user acquires the target region image, and the mobile phone of the user may process the target region image to obtain the prediction result. The prediction result may include the image validity information or include the state information of the at least one target object, or may include both the image validity information and the state information of the at least one target object. For example, for the target region image acquired by the mobile phone of the user, there may be various conditions such as the eye is occluded or the target region image is blurry, the mobile phone of the user may process the target region image to obtain the prediction result, for example, obtaining a prediction result including the image validity information, and the image validity information may indicate that the target region image is invalid.

In some embodiments, the operation that the target region image is processed to obtain the prediction result, the prediction result including at least one of the image validity information of the target region image or the state information of the at least one target object (S1021) may include the following operations. Feature extraction processing is performed on the target region image to obtain the feature information of the target region image; and the prediction result is obtained according to the feature information. For example, the mobile phone of the user may perform feature extraction processing on the target region image to obtain the feature information of the target region image. It is to be understood that the feature information of the target region image may be acquired in multiple manners. For example, feature extraction processing may be performed on the target region image through a convolutional neural network to obtain the feature information of the target region image. No limits are made thereto in the embodiment of the disclosure. Then, a relatively accurate prediction result may be obtained through the feature information.

In some embodiments, feature extraction processing may be performed on the target region image by use of a deep ResNet to obtain the feature information of the target region image.

FIG. 5 is a schematic diagram of an example of an image processing network configured to implement a method for image processing according to embodiments of the disclosure. There is made such a hypothesis that the image processing network is a ResNet-based deep ResNet, but it is understood by those skilled in the art that the image processing network may also be implemented by another type of neural network. No limits are made thereto in the embodiment of the disclosure.

As shown in FIG. 5, the deep ResNet includes a convolutional layer 51, configured to extract basic information of an input image (for example, the target region image) and reduce a feature map dimensionality of the input image. The deep ResNet further includes two ResNet blocks 52 (for example, a ResNet block 1 and a ResNet block 2). The ResNet block 52 includes a residual unit, and the residual unit may reduce the complexity of a task without changing an overall input/output of the task. The ResNet block 1 may include one or more convolutional layers and one or more Batch Normalization (BN) layers, and may be configured to extract the feature information. The ResNet block 2 may include one or more convolutional layers and one or more BN layers, and may be configured to extract the feature information. The ResNet block 2 may structurally include one more convolutional layer and BN layer than the ResNet block 1, so that the ResNet block 2 may further be configured to reduce the feature map dimensionality. In such a manner, the feature information of the target region image may be obtained relatively accurately by use of the deep ResNet. It is to be understood that feature extraction processing may be performed on the target region image by use of any convolutional neural network structure to obtain the feature information of the target region image and no limits are made thereto in the embodiment of the disclosure.

In some embodiments, the prediction result may be obtained according to the feature information.

For example, analytic processing may be performed according to the feature information to obtain the prediction result. Descriptions are now made with the condition that the prediction result includes both the image validity information of the target region image and the state information of the at least one target object as an example. For example, as shown in FIG. 5, the deep ResNet may further include a fully connected layer 53, for example, including three fully connected layers. The fully connected layer may perform dimensionality reduction processing on the feature information of the target region image, for example, reducing from three dimensions to two dimensions, and simultaneously retain useful information.

As shown in FIG. 5, the deep ResNet may further include an output segmentation layer 54, and the output segmentation layer may perform output segmentation processing on an output of the last fully connected layer to obtain the prediction result. For example, output segmentation processing is performed on the output of the last fully connected layer to obtain two prediction results to obtain the image validity information 55 of the target region image and the state information 56 of the at least one target object respectively. Therefore, the prediction result may be obtained relatively accurately. It is to be understood that the target region image may be processed in multiple manners to obtain the prediction result, not limited to the above example.

As shown in FIG. 4, in S1022, the state of each of the at least one target object is determined according to at least one of the image validity information or the state information of the at least one target object.

In some embodiments, the image validity information of the target region image may be determined based on the feature information of the target region image, and the state of each of the at least one target object may be determined based on the image validity information of the target region image. For example, the feature information of the target region image may be acquired. For example, feature extraction may be performed on the target region image through the trained neural network to obtain the feature information of the target region image, and the image validity information of the target region image may be determined according to the feature information of the target region image. For example, the feature information of the target region image is processed, for example, input to a fully connected layer of the neural network for processing, to obtain the image validity information of the target region image. The state of each of the at least one target object is determined based on the image validity information of the target region image. A manner for determining the feature information of the target region image, a manner for determining the image validity information of the target region image, and a manner for determining the state of each of the at least one target object based on the image validity information of the target region image are not limited in the disclosure.

For example, if the mobile phone of the user acquires the image validity information, the mobile phone of the user may determine the state of each of the at least one target object according to the image validity information. If the mobile phone of the user acquires the state information of the at least one target object, the mobile phone of the user may determine the state of each of the at least one target object according to the state information of the at least one target object. If the mobile phone of the user acquires both the image validity information and the state information of the at least one target object, the state of each of the at least one target object may be determined according to at least one of the image validity information or the state information of the at least one target object. Therefore, the state of each of the at least one target object may be determined in multiple manners. A manner for determining the state of each of the at least one target object according to the prediction result is not limited in the disclosure.

In some embodiments, the operation that the state of each of the at least one target object is determined according to at least one of the image validity information or the state information of the at least one target object (S1022) may include the following operation.

Under the condition that the image validity information indicates that the target region image is invalid, it is determined that the state(s) of the at least one target object is/are eye-closed, or, responsive to that the image validity information indicates that the target region image is invalid, it is determined that the state(s) of the at least one target object is/are eye-closed. In an example, responsive to that the image validity information indicates that the target region image is invalid, it is determined that the state of each of the at least one target object is eye-closed.

In some embodiments, the operation that the state of each of the at least one target object is determined according to at least one of the image validity information or the state information of the at least one target object (S1022) may include the following operation. Responsive to the image validity information indicating that the target region image is valid, the state of each of the at least one target object is determined based on the state information of each of the at least one target object.

In some embodiments, the operation that the state of each of the at least one target object is determined according to at least one of the image validity information or the state information of the at least one target object includes the following operation. Responsive to the image validity information indicating that the target region image is valid, the state of each of the at least one target object is determined based on the state information of each of the at least one target object. For example, responsive to the prediction result acquired by the mobile phone of the user including the image validity information and the image validity information indicating that the target region image is invalid, it may be determined that the state of each of the at least one target object is eye-closed.

In some embodiments, the image validity information may include a validity confidence, the validity confidence being information configured to indicate a probability that the image validity information is valid. For example, a first threshold configured to judge whether the target region image is valid or invalid may be preset. For example, when the validity confidence in the image validity information is lower than the first threshold, it may be determined that the target region image is invalid, and when the target region image is invalid, it may be determined that the state of each of the at least one target object is eye-closed. In such a manner, the state of each of the at least one target object may be determined rapidly and effectively. A manner for determining that the image validity information indicates that the target region image is invalid is not limited in the disclosure.

In some embodiments, the state information of the target object may include an eye-open confidence or an eye-closed confidence. The eye-open confidence is information configured to indicate a probability that the state of the target object is eye-opened, and the eye-closed confidence is information configured to indicate a probability that the state of the target object is eye-closed. In some embodiments, the operation that the state of each of the at least one target object is determined according to at least one of the image validity information or the state information of the at least one target object (S1022) may include the following operation. Responsive to the validity confidence exceeding the first threshold and the eye-open confidence of the target object exceeding a second threshold, it is determined that the state of the target object is eye-open.

In another example, responsive to the validity confidence being lower than the first threshold or the eye-open confidence of a certain target object being lower than the second threshold, it is determined that the state of the target object is eye-closed. For example, the second threshold configured to judge that the state(s) of the at least one target object is/are eye-open or eye-closed may be preset. For example, when the eye-open confidence(s) in the state information exceeds the second threshold, it may be determined that the state(s) of the at least one target object is/are eye-open, and when the eye-open confidence(s) in the state information is/are lower than the second threshold, it may be determined that the state(s) of the at least one target object is/are eye-closed. Under the condition that the validity confidence in the image validity information in the prediction result exceeds the first threshold (in such case, the image validity information indicates that the target region image is valid) and the eye-open confidence(s) of the target object(s) exceeds the second threshold (in such case, the state information indicates that the state(s) of the at least one target object is/are eye-open), the mobile phone of the user may determine that the state(s) of the target object(s) is/are eye-open. Under the condition that the validity confidence in the image validity information in the prediction result is lower than the first threshold or the eye-open confidence of a certain target object is lower than the second threshold, it may be determined that the state of the target object is eye-closed. In such a manner, the state(s) of the at least one target object may be determined relatively accurately to judge whether the user knows identity authentication. It is to be understood that the first threshold and the second threshold may be set by the system. A determination manner for the first threshold and the second threshold and specific numerical values of the first threshold and the second threshold are not limited in the disclosure.

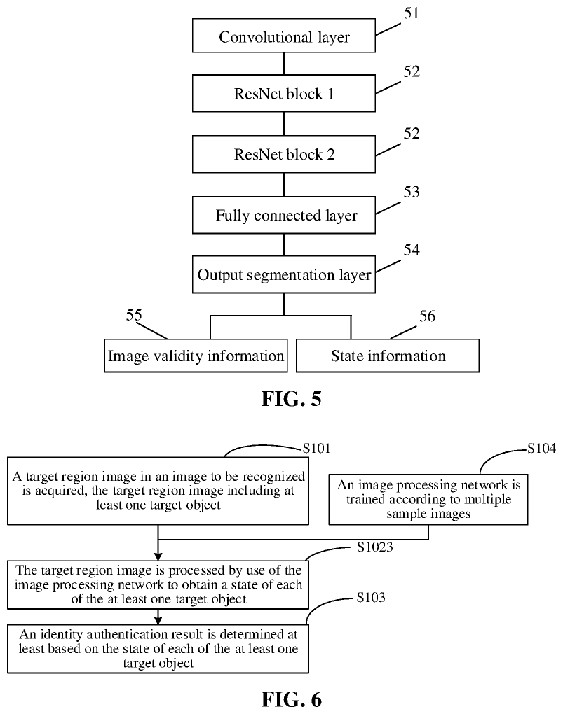

FIG. 6 is another flowchart of a method for image processing according to embodiments of the disclosure. In some embodiments, as shown in FIG. 6, S102 may include the following operation.

In S1023, the target region image is processed by use of an image processing network to obtain the state of each of the at least one target object.

The image processing network may be acquired from another device, for example, acquired from a cloud platform or acquired from a software storage medium. In some optional embodiments, the image processing network may also be pretrained by the electronic device executing the method for image processing, and correspondingly, the method may further include the following operation. In S104, the image processing network is trained according to multiple sample images.

The image processing network may include the abovementioned deep ResNet, and the image processing network may be trained according to the multiple sample images. The target region image may be input to the trained image processing network and processed to obtain the state of each of the at least one target object. Therefore, the state of each of the at least one target object may be obtained relatively accurately through the image processing network trained according to the multiple sample images. A structure of the image processing network, a process of training the image processing network according to the multiple sample images and the like are not limited in the disclosure.

FIG. 7 is a flowchart of a training method for an image processing network according to embodiments of the disclosure. In some embodiments, as shown in FIG. 7, S104 may include the following operations.

In S1041, the multiple sample images are preprocessed to obtain multiple preprocessed sample images.

In S1042, the image processing network is trained according to the multiple preprocessed sample images.

For example, the multiple sample images may be preprocessed by operations of, for example, translation, rotation, scaling and motion blurring addition to obtain the multiple preprocessed sample images, thereby training and obtaining the image processing network applicable to various complex scenarios according to the multiple preprocessed sample images. In the process of preprocessing the multiple sample images to obtain the multiple preprocessed sample images, labeling information of part of sample images is not required to be changed, and labeling information of part of sample images is required to be changed. The labeling information may be information manually labeled for network training according to a state of the sample image (for example, whether the sample image is valid and whether a state of a target object in the sample image is eye-open or eye-closed). For example, if the sample image is blurry, the labeling information may include image validity information, and the manually labeled image validity information indicates that the sample image is invalid, etc. For example, in the process of preprocessing the multiple sample images, the labeling information of the sample images obtained after the operation of motion blurring addition is executed for preprocessing may be controlled to be changed, and the labeling information of the sample images obtained after other operations are executed for preprocessing is not required to be changed.

For example, the image processing network may be trained according to the multiple preprocessed sample images. For example, the image processing network is trained by taking the multiple preprocessed sample images as training samples and taking the labeling information corresponding to the multiple preprocessed sample images as supervisory information for training of the image processing network. In such a manner, an image processing network applicable to multiple complex scenarios may be trained to improve the image processing accuracy. A preprocessing manner, a labeling manner, a form of the labeling information and the specific process of training the image processing network according to the multiple preprocessed sample images are not limited in the disclosure.

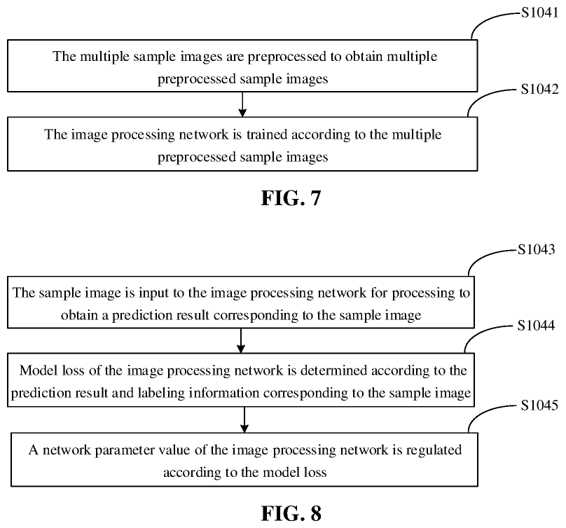

FIG. 8 is another flowchart of a training method for an image processing network according to embodiments of the disclosure. A processing flow corresponding to a certain sample image in the multiple sample images is as follows.

In S1043, the sample image is input to the image processing network and processed to obtain a prediction result corresponding to the sample image.

In S1044, model loss of the image processing network is determined according to the prediction result and labeling information corresponding to the sample image.

In S1045, a network parameter value of the image processing network is regulated according to the model loss.

For example, the sample image may be input to the image processing network and processed to obtain the prediction result corresponding to the sample image, the model loss of the image processing network may be determined according to the prediction result and the labeling information corresponding to the sample image, and the network parameter value of the image processing network may be regulated according to the model loss. For example, the network parameter value is regulated by a backward gradient algorithm and the like. It is to be understood that the network parameter value of the feature extraction network may be regulated appropriately and no limits are made thereto in the embodiment of the disclosure. After regulation is performed for many times and if a preset training condition is met, for example, a regulation frequency reaches a preset training frequency threshold, or the model loss is less than or equal to a preset loss threshold, a present image processing network may be determined as a final image processing network, thereby completing the training process of the feature extraction network. It is to be understood that those skilled in the art may set the training condition and the loss threshold according to a practical condition and no limits are made thereto in the embodiment of the disclosure. In such a manner, an image processing network capable of accurately obtaining the state of each of the at least one target object may be trained.

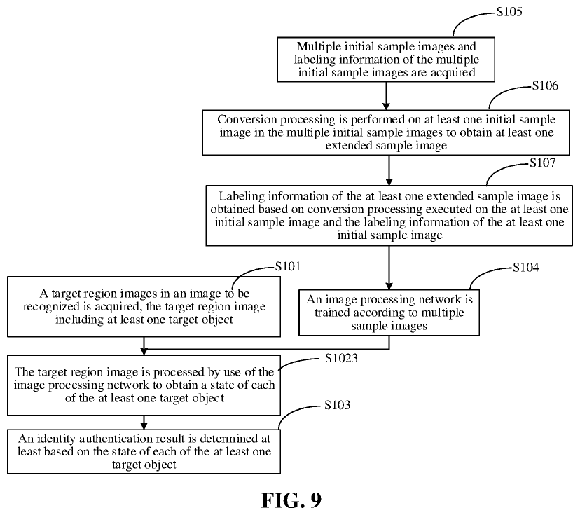

FIG. 9 is another flowchart of a method for image processing according to embodiments of the disclosure. In the example, there is made such a hypothesis that the image processing network is pretrained and tested by the electronic device. However, it is understood by those skilled in the art that the training method, testing method and application method for the neural network may be executed by the same device or executed by different devices respectively. No limits are made thereto in the embodiment of the disclosure.

In S105, multiple initial sample images and labeling information of the multiple initial sample images are acquired. For example, the multiple initial sample images may be multiple initial sample images obtained by capturing the image to be recognized (training sample set images in the image to be recognized). For example, if the trained image processing network is expected to be configured to process the target region image (for example, the image nearby the eye(s) in the face image), the training sample set images (for example, face images) in the image to be recognized may be captured to obtain target region images (images nearby the eye(s) in the face image) in the training sample set image, and the acquired target region images in the training sample set images are determined as the multiple initial sample images.

In some embodiments, eye key points of the face in the image to be recognized may be labeled, for example, key points nearby the eye are labeled, and the image nearby the eye is captured, for example, an image nearby an eye is captured as a rectangular image and a mirroring operation is executed to capture a rectangular image nearby the other eye, thereby obtaining multiple initial sample images.

In some embodiments, the multiple initial sample images may be manually labeled. For example, image validity information of the initial sample image and the state information may be labeled according to whether the initial sample image is valid (for example, whether the image is clear and whether the eye in the image is clear) and whether a state of the eye is open or closed. For example, for a certain initial sample image, if the image and the eye are clear and the eye is in an open state, labeling information obtained by labeling may be valid (representing that the image is valid) and open (representing that the eye is in the open state). The labeling manner and the form of the labeling information are not limited in the disclosure. In S106, conversion processing is performed on at least one initial sample image in the multiple initial sample images to obtain at least one extended sample image, conversion processing including at least one of occluding, image exposure changing, image contrast changing or transparentizing processing. For example, part or all of the initial sample images may be extracted from the multiple initial sample images, and conversion processing is performed on the extracted initial sample images according to complex conditions probably occurring in a Red Green Blue (RGB) color mode and an Infrared Radiation (IR) camera shooting scenario (for example, various IR camera and RGB camera-based self-timer scenarios). For example, conversion processing including, but not limited to, at least one of occluding, image exposure changing, image contrast changing or transparentizing processing may be performed to obtain the at least one extended sample image.

In S107, labeling information of the at least one extended sample image is obtained based on conversion processing executed on the at least one initial sample image and the labeling information of the at least one initial sample image, the multiple sample images including the multiple initial sample images and the at least one extended sample image. For example, after conversion processing is executed on the at least one initial sample image, the labeling information of the at least one extended sample image may be obtained based on a conversion processing manner and the labeling information of the at least one initial sample image. For example, for an initial sample image 1, if the image and the eye are clear and the eye is in the open state, labeling information of the initial sample image 1 may be valid and open. For an extended sample image obtained after transparentizing processing is performed on the initial sample image 1, if the image and the eye are still clear and the eye is still in the open state, labeling information of the extended sample image is the same as the labeling information of the initial sample image 1.

In some embodiments, for an initial sample image 2, if the image and the eye are clear and the eye is in the open state, labeling information of the initial sample image 2 may be valid (representing that the image is valid) and open (representing that the eye is in the open state). For an extended sample image obtained after conversion processing (for example, the eye is occluded) is performed on the initial sample image 2, if the eye is no more clear, labeling information, that is invalid (representing that the image is invalid) and close (representing that the eye is in a closed state), of the extended sample image may be obtained based on the initial sample image 2 according to a condition after conversion processing.

In some embodiments, the multiple initial sample images and the at least one extended sample image may be determined as the multiple sample images. For example, 500,000 initial sample images are acquired according to the training sample set in the image to be recognized, and conversion processing is performed on 200,000 initial sample images therein to obtain 200,000 extended sample images. In such case, the 500,000 initial sample images and the 200,000 extended sample images may be determined as multiple (700,000) images configured to train the image processing network. Therefore, multiple sample images with many complex conditions may be obtained. The number of the initial sample images and the number of the extended sample images are not limited in the disclosure.

By determining the multiple initial sample images and the at least one extended sample image as the multiple sample images, a training dataset configured to train the image processing network is extended, so that the trained image processing network may be applied to various relatively complex scenarios, and the processing capability of the image processing network may be improved. For example, conversion processing is performed on the multiple initial sample images according to a complex condition probably occurring in an RGB color mode-based camera shooting scenario to obtain the at least one extended sample image, and through the image processing network trained by the sample images including the extended sample image, the state of each of the at least one target object in the target region image in the image to be recognized of the RGB color mode-based camera shooting scenario may be determined relatively accurately to ensure the robustness and accuracy of the image processing method of the embodiments of the disclosure. A determination manner for the multiple sample images is not limited in the disclosure.

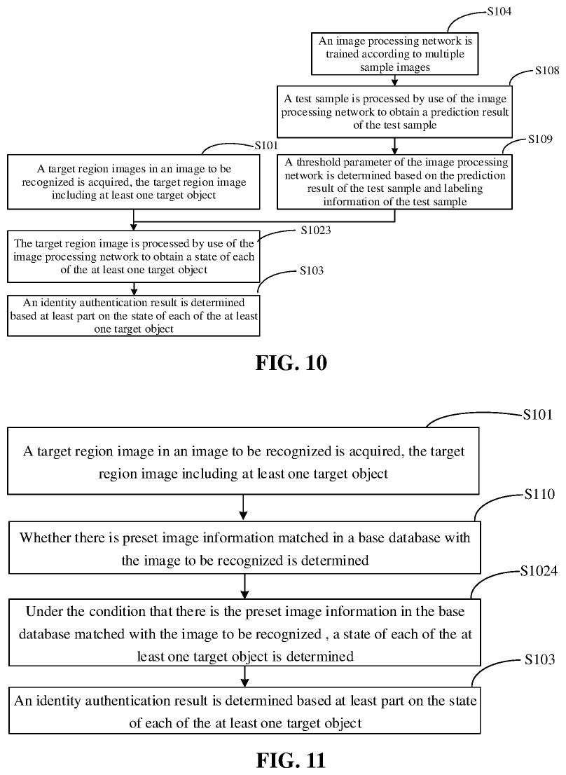

FIG. 10 is another flowchart of a method for image processing according to embodiments of the disclosure. In some embodiments, as shown in FIG. 10, the method further includes the following operations.

In S108, a test sample is processed by use of the image processing network to obtain a prediction result of the test sample.

In S109, threshold parameters of the image processing network are determined based on the prediction result of the test sample and labeling information of the test sample. The threshold parameter may be a threshold required to be used in the process of determining the state of each of the at least one target object by use of the image processing network. For example, the abovementioned first threshold and second threshold may be included. The number and type of the threshold parameters are not limited in the embodiment of the disclosure.

Descriptions are now made with the condition that the target region image includes the first region image and the second region image, the first region image includes the right eye, the second region image includes the left eye and the prediction result includes both the image validity information and the state information as an example. For example, the test sample may be processed by use of the image processing network to obtain the prediction result of the test sample. For example, the image validity information and state information of the right eye and the image validity information and state information of the left eye are obtained respectively.

In some embodiments, the threshold parameters of the image processing network may be determined based on a prediction result of the right eye (the image validity information and state information of the right eye), a prediction result of the left eye (the image validity information and state information of the left eye) and the labeling information of the test sample. For example, prediction results of multiple test samples may be output to a text file, and the prediction results of the multiple test samples are compared with labeling information of the test samples to determine the first threshold and the second threshold respectively. Descriptions are now made with the condition that the first threshold is determined according to image validity information in the prediction results of the multiple test samples and image validity information in the labeling information of the test samples as an example.

In some embodiments, a value of F1 may be determined according to a precision ratio and a recall ratio, and a threshold corresponding to a maximum value of F1 is determined as the first threshold. The precision ratio is configured to represent a proportion of actually positive examples in divided positive examples, and the recall ratio is configured to represent the number of positive examples that are divided into positive examples. A positive example may refer to that image validity information exceeds a present threshold, and labeling information is valid (representing that the image is valid).

An exemplary determination formula (1) for the value of F1 is provided below:

$$F 1 = \frac{2 \times Ps \times Rc}{Ps + Rc} . \qquad ( 1 )$$

In the formula (1), Ps represents the precision ratio, and Rc represents the recall ratio.

An exemplary determination formula (2) for the precision ratio Ps is provided below:

$$Ps = \frac{{T}_{1}}{{T}_{1} + {F}_{1}} . \qquad ( 2 )$$

In the formula (2), Ps represents the precision ratio, T₁ represents a numerical value indicating the number of the samples of which the image validity information exceeds the present threshold and the labeling information is valid (representing that the image is valid), and F₁ represents a numerical value indicating the number of the samples of which the image validity information exceeds the preset threshold and the labeling information is invalid (representing that the image is invalid).

An exemplary determination formula (3) for the recall ratio Rc is provided below:

$$Rc = \frac{{T}_{1}}{{T}_{1} + {F}_{0}} . \qquad ( 3 )$$

In the formula (3), Rc represents the recall ratio, T₁represents a numerical value indicating the number of the samples of which the image validity information exceeds the present threshold and the labeling information is valid (representing that the image is valid), and F₀ represents a numerical value indicating the number of the samples of which the image validity information is lower than the preset threshold and the labeling information is valid (representing that the image is valid). It is to be understood that, if a threshold (present threshold) is given, the numerical values of T₁, F₁ and F₀ may be determined according to the image validity information and the image validity information in the labeling information of the test samples respectively, and the precision ratio Ps and the recall ratio Rc may be determined according to the numerical values of T₁, F₁ and F₀ and according to the formulae (2) and (3). A corresponding value of F1 under the present given threshold may be determined according to the formula (1), the precision ratio Ps and the recall ratio Rc. Apparently, there may be a threshold corresponding to the maximum value of F1, and in such case, the threshold is determined as the first threshold.

In some embodiments, a value of Mx may be determined according to a true positive rate and a false positive rate, and a threshold corresponding to a maximum value of Mx is determined as the first threshold. The true positive rate is configured to represent the number of positive examples that are divided into positive examples, and the false positive rate is configured to represent the number of counter examples that are divided into positive examples. A positive example may refer to that image validity information exceeds the present threshold, and labeling information is valid (representing that the image is valid). A counter example may refer to that image validity information exceeds the present threshold, and labeling information is invalid (representing that the image is invalid).

An exemplary determination formula (4) for the value of Mx is provided below:

Mx=Tpr−Fpr (4).

In the formula (4), Tpr represents the true positive rate, and Fpr represents the false positive rate.

An exemplary determination formula (5) for the true positive rate Tpr is provided below:

$$Tpr = \frac{{T}_{1}}{{T}_{1} + {F}_{0}} . \qquad ( 5 )$$

In the formula (5), Tpr represents the true positive rate, T₁ represents a numerical value indicating the number of the samples of which the image validity information exceeds the present threshold and the labeling information is valid (representing that the image is valid), and F₀ represents a numerical value indicating the number of the samples of which the image validity information is less than or equal to the preset threshold and the labeling information is valid (representing that the image is valid).

An exemplary determination formula (6) for the false positive rate Fpr is provided below:

$$Fpr = \frac{{F}_{1}}{{T}_{0} + {F}_{1}} . \qquad ( 6 )$$

In the formula (6), Fpr represents the false positive rate, T₀ represents a numerical value indicating the number of the samples of which the image validity information is lower than the present threshold and the labeling information is invalid (representing that the image is invalid), and F₁ represents a numerical value indicating the number of the samples of which the image validity information is greater than the preset threshold and the labeling information is invalid (representing that the image is invalid).

It is to be understood that, if a threshold (present threshold) is given, the numerical values of T₁, T₀, F₁ and F₀ may be determined according to the image validity information and the image validity information in the labeling information of the test samples respectively, and the true positive rate Tpr and the false positive rate Fpr may be determined according to the numerical values of T₁, T₀, F₁ and F₀ and according to the formulae (5) and (6). A corresponding value of Mx under the present given threshold may be determined according to the formula (4), the true positive Tpr and the false positive rate Fpr. Apparently, there may be a threshold corresponding to the maximum value of Mx, and in such case, the threshold is determined as the first threshold. It is understood by those skilled in the art that the second threshold may also be determined by the abovementioned exemplary method. In such a manner, the threshold parameters (for example, the first threshold and the second threshold) configured to determine the image processing network may be determined, and the threshold parameters may be configured to determine the state of each of the at least one target object. A determination manner for the threshold parameters of the image processing network is not limited in the disclosure. Therefore, the state of each of the at least one target object may be determined based on the target region image in multiple manners to determine the identity authentication result based at least part on the state of each of the at least one target object. Determination of the state of each of the at least one target object based on the target region image is not limited in the disclosure.

FIG. 11 is another flowchart of a method for image processing according to embodiments of the disclosure. In some embodiments, as shown in FIG. 11, before the operation that the state of each of the at least one target object is determined based on the target region image, the method further includes the following operation. In S110, whether there is preset image information matched with the image to be recognized in a base database is determined. The base database may be configured to store preset image information for identity authentication. For example, when identity authentication is performed by face recognition, a face image of a reference object may be acquired in advance, the reference object being a legal authentication subject in an identity authentication process. For example, if the identity authentication is an authentication for a certain user to unlock a terminal thereof, the user is the legal authentication subject, i.e., the reference object, in the identity authentication process. For example, the face image of the user of the mobile phone is acquired, and the reference face image may be stored in the base database as a preset image for identity authentication.

As shown in FIG. 11, the operation that the state of each of the at least one target object is determined based on the target region image (S102) may include the following operation. In S1024, responsive to there being the preset image information matched with the image to be recognized in the base database, the state of each of the at least one target object is determined.

For example, responsive to determining that there is the preset image information matched with the image to be recognized in the base database, the state of each of the at least one target object may be determined for identity authentication. For example, the mobile phone of the user may acquire the image to be recognized (the face image) and the target region image (the image nearby the eye) in the face image through a camera, and the mobile phone of the user may determine whether there is the preset image information matched with the face image in the base database, and for example, may compare the preset image information and the face image to determine whether they are matched. If there is preset image information matched with the image to be recognized, the mobile phone of the user may determine the state of each of the at least one eye in the face image, thereby determining the identity authentication result according to the state of each of the at least one eye. In such a manner, the state, obtained responsive to determining that there is the preset image information matched with the image to be recognized in the base database, of each of the at least one target object may ensure that the at least one target object configured to determine the identity authentication result is a target object of the preset reference object, so that the accuracy of the identity authentication result may be effectively improved. A manner for determining whether there is the preset image information matched with the image to be recognized in the base database is not limited in the disclosure.

As shown in FIG. 1, in S103, the identity authentication result is determined based at least part on the state of each of the at least one target object. For example, the mobile phone of the user may determine the identity authentication result based on the state of each of the at least one target object. For example, as mentioned above, the mobile phone of the user may determine the state of each of the at least one target object in multiple manners, and the mobile phone of the user may determine the identity authentication result according to the state of each of the at least one target object. For example, the mobile phone of the user, responsive to determining that the state of each of the at least one eye is open, may determine the identity authentication result indicating, for example, authentication succeeds or authentication fails, based at least part on the open state of each of the at least one eye. A manner for determining the identity authentication result based at least part on the state of each of the at least one target object is not limited in the disclosure.

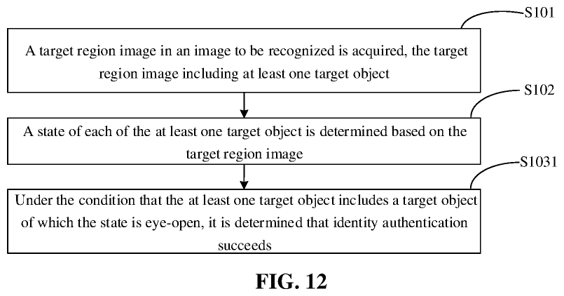

FIG. 12 is another flowchart of a method for image processing according to embodiments of the disclosure. In some embodiments, as shown in FIG. 12, S103 may include the following operation.

In S1031, responsive to that the at least one target object includes a target object of which the state is eye-open, it is determined that identity authentication succeeds.

In some embodiments, it may be determined that identity authentication succeeds at least partially responsive to that the state of at least one target object is eye-open. For example, there is made such a hypothesis that the at least one target object is two target objects, and in such case, responsive to that a state of one target object is eye-open and a state of the other target object is eye-closed or responsive to that the state of each of the two target objects is eye-open, it is determined that identity authentication succeeds.

In some embodiments, face recognition may be performed based on a face image of a person corresponding to the target region image responsive to the at least one target object including the target object of which the state is eye-open, and the identity authentication result may be determined based on a face recognition result. For example, it may be determined that identity authentication succeeds responsive to the face recognition result being that recognition succeeds, and it may be determined that identity authentication fails responsive to the face recognition result being that recognition fails.

In some other embodiments, it may be determined that identity authentication succeeds only responsive to the state of each of the at least one target object is eye-open. In such case, if the at least one target object includes a target object of which the state is eye-closed, it may be determined that identity authentication fails. For example, it may be preset that, responsive to that the at least one target object in the image to be recognized includes the target object of which the state is eye-open, it is determined that identity authentication succeeds. For example, the mobile phone of the user determines that the two eyes of the face image include an eye (for example, the left eye), of which the state is open and determines that identity authentication succeeds. Therefore, the identity authentication security may be improved. It is to be understood that a condition for successful identity authentication may be set according to a requirement on the identity authentication security. For example, it may be set that, when the state of each of the two eyes in the image to be recognized is open, it is determined that identity authentication succeeds. No limits are made thereto in the embodiment of the disclosure.

In some embodiments, the mobile phone of the user acquires the image to be recognized (for example, the face image). The mobile phone of the user may determine whether there is the preset image information matched with the image to be recognized in the base database. For example, the mobile phone of the user determines that the face image is matched with the preset image information of the reference object in the base database. The mobile phone of the user may acquire the one ore more target region images in the face image, for example, acquiring the images nearby the left and right eyes respectively (for example, the first region image and the second region image respectively). The mobile phone of the user may determine the state of each of the at least one target object based on the target region image. For example, the mobile phone of the user processes the first region image and the second region image through the trained image processing network to obtain the state of each of the at least one target object., for example, obtaining the open state of the right eye and the closed state of the left eye. The mobile phone of the user, responsive to determining that the face image is matched with the preset image information of the reference object in the base database and the state of the at least one target object (the eye) is eye-open, may determine that identity authentication succeeds.

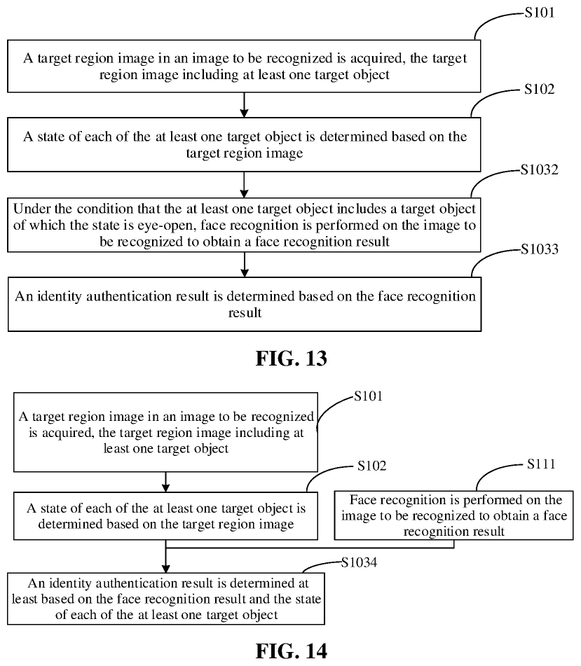

FIG. 13 is another flowchart of a method for image processing according to embodiments of the disclosure. In some embodiments, as shown in FIG. 13, S103 may include the following operations.

In S1032, responsive to the at least one target object including the target object of which the state is eye-open, face recognition is performed on the image to be recognized to obtain the face recognition result. In S1033, the identity authentication result is determined based on the face recognition result. For example, the mobile phone of the user, responsive to determining that the at least one target object includes the target object of which the state is eye-open, may perform face recognition on the image to be recognized to obtain the face recognition result. For example, face feature information and the like in the image to be recognized may be acquired in multiple manners.

In some embodiments, whether there is reference image information matched with the image to be recognized in the base database may be determined, and responsive to determining that there is the reference image information matched with the image to be recognized in the base database, it is determined that face recognition succeeds. For example, preset image information in the base database may include preset image feature information, and whether there is the preset image information in the base database matched with the image to be recognized is determined based on a similarity between feature information of the image to be recognized and at least one piece of preset image feature information. A face recognition manner, a content and form of the face recognition result, a standard for successful or failed face recognition and the like are not limited in the disclosure.

In some embodiments, the state of each of the at least one target object is determined after face recognition of the image to be recognized succeeds, or, face recognition of the image to be recognition and determination of the state of each of the at least one target object are executed at the same time, or, face recognition is executed on the image to be recognized after the state of each of the at least one target object is determined.

The mobile phone of the user may determine the identity authentication result based on the face recognition result. For example, the reference image (for example, the face image that is shot and stored in advance) of the reference object (for example, the user of the mobile phone) may be pre-stored, and the mobile phone of the user may compare the face recognition result (for example, the face feature information) and feature information of the reference image of the reference object to determine a matching result. For example, when the face recognition result is matched with the reference image, it may be determined that identity authentication succeeds, and when the face recognition result is not matched with the reference image, it may be determined that identity authentication fails. Therefore, responsive to determining that the at least one target object includes the target object of which the state is eye-open, it may be judged that the user knows the present identity authentication process, and the identity authentication result determined according to the face recognition result obtained by face recognition has the characteristics of high accuracy, high security and the like. The face recognition manner, the form of the face recognition result, a manner for determining the identity authentication result based on the face recognition result and the like are not limited in the disclosure.

FIG. 14 is another flowchart of a method for image processing according to embodiments of the disclosure. In some embodiments, as shown in FIG. 14, the method further includes the following operation. In S111, face recognition is performed on the image to be recognized to obtain the face recognition result.

Correspondingly, S103 may include the following operation. In S1034, the identity authentication result is determined based at least part on the face recognition result and the state of each of the at least one target object.

In some embodiments, the state of each of the at least one target object is determined after face recognition of the image to be recognized succeeds, or, face recognition of the image to be recognition and determination of the state of each of the at least one target object are executed at the same time, or, face recognition is executed on the image to be recognized after the state of each of the at least one target object is determined. For example, the mobile phone of the user may perform face recognition on the image to be recognized, for example, performing face recognition on the image to be recognized before, after or at the same time when the state of each of the at least one target object is determined, to obtain the face recognition result. The face recognition process is as mentioned above and will not be elaborated herein.

In an example, responsive to that the face recognition result is that the recognition succeeds and the at least one target object includes the target object of which the state is eye-open, it is determined that identity authentication succeeds. In another example, responsive to that the face recognition result is that the recognition fails or the state of each of the at least one target object is eye-closed, it is determined that identity authentication fails.

For example, the mobile phone of the user may determine the identity authentication result based on the face recognition result and the state of each of the at least target object. For example, a condition for successful authentication may be preset. For example, if the face recognition result indicates that the face image in the image to be recognized is not the reference object, it may be determined based on the face recognition result and the state of each of the at least one target object that identity authentication fails. If the face recognition result indicates that the face image in the image to be recognized is the reference object, the identity authentication result may be determined according to the face recognition result and the state of each of the at least one target object. For example, it is set that, when the state of at least one target object is eye-open, it is determined that identity authentication succeeds. The mobile phone of the user, responsive to determining that the face recognition result indicates that the face image in the image to be recognized is the reference object and the state of at least one target object is eye-open, determines that the identity authentication result is that authentication succeeds. Therefore, improvement of the identity authentication security is facilitated. The face recognition manner, the form of the face recognition result, the manner for determining the identity authentication result based on the face recognition result and the like are not limited in the disclosure.

In some embodiments, the method further includes the following operation. Liveness detection is performed on the image to be recognized to determine a liveness detection result. The operation that the identity authentication result is determined based at least part on the face recognition result and the state of each of the at least one target object includes that: the identity authentication result is determined based on the face recognition result, the liveness detection result and the state of each of the at least one target object.

In an example, responsive to that the face recognition result is that the recognition succeeds, the liveness detection result indicates a living body and the at least one target object includes the target object of which the state is eye-open, it is determined that identity authentication succeeds. In another example, responsive to that the face recognition result is that the recognition fails, or the liveness detection result indicates a non-living body or the state of each of the at least one target object is eye-closed, it is determined that identity authentication fails. Therefore, improvement of the identity authentication security is facilitated. A specific manner for liveness detection, a form of the liveness detection result and the like are not limited in the disclosure.

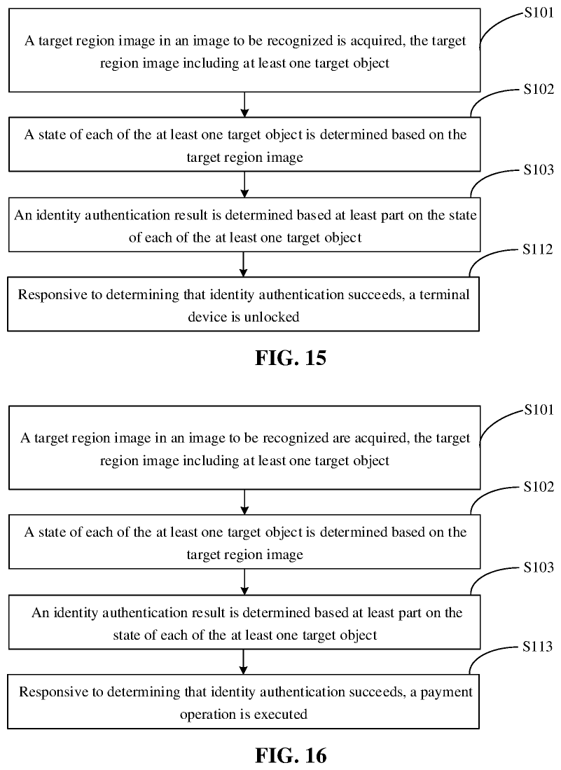

FIG. 15 is another flowchart of a method for image processing according to embodiments of the disclosure. In some embodiments, as shown in FIG. 15, the method further includes the following operation. In S112, responsive to determining that identity authentication succeeds, a terminal device is unlocked. For example, the mobile phone of the user has a face unlocking function, and when the mobile phone of the user is in a locked state, the user may not use the mobile phone. When the user expects to unlock the mobile phone, the image to be recognized, for example, the face image of the user, may be acquired through the camera of the mobile phone, identity authentication is performed based on the face image, and responsive to determining that identity authentication succeeds, the terminal device may be unlocked. For example, the user may unlock the mobile phone of the user without inputting an unlocking code, and the user may normally use the mobile phone. Therefore, the user may conveniently and rapidly unlock the terminal device, and meanwhile, the security of the terminal device may be ensured. It is to be understood that there may be multiple locking conditions for the terminal device. For example, the mobile phone is locked, and the user may not use the mobile phone. Or, a certain application program of the terminal device is locked. No limits are made thereto in the embodiment of the disclosure.

FIG. 16 is another flowchart of a method for image processing according to embodiments of the disclosure. In some embodiments, as shown in FIG. 16, the method further includes the following operation.

In S113, responsive to determining that identity authentication succeeds, a payment operation is executed. For example, the user may execute various payment operations through the terminal device (for example, the mobile phone). When the payment operation is executed, fast payment may be implemented by identity authentication. For example, when the user expects to pay, the image to be recognized, for example, the face image of the user, may be acquired through the camera of the mobile phone, identity authentication is performed based on the face image, and responsive to determining that identity authentication succeeds, the payment operation may be executed. For example, the user may execute the payment operation without inputting a payment code. Therefore, the user may conveniently implement fast payment, and the payment security may be ensured. An application scenario of the payment operation is not limited in the embodiment of the disclosure. It is to be noted that the identity authentication result determined in the embodiments of the disclosure may be applied to various application scenarios. For example, as mentioned above, responsive to determining that identity authentication succeeds, the terminal device is unlocked, and the payment operation is executed, etc. In addition, the identity authentication result may also be applied to various application scenarios such as access control unlocking, login with various virtual accounts, association of multiple accounts of the same user and identity authentication of the user if the operations may be executed based on the identity authentication result. The application scenario of the determined identity authentication result is not limited in the disclosure.

In some embodiments, the method further includes the following operations.

In S121, the multiple initial sample images and the labeling information of the multiple initial sample images are acquired.

In S122, conversion processing is performed on the at least one initial sample image in the multiple initial sample images to obtain the at least one extended sample image, conversion processing including at least one of occluding, image exposure changing, image contrast changing or transparentizing processing.

In S123, the labeling information of the at least one extended sample image is obtained based on conversion processing executed on the at least one initial sample image and the labeling information of the at least one initial sample image.

In S124, the image processing network is trained based on a training sample set including the multiple initial sample images and the at least one extended sample image.

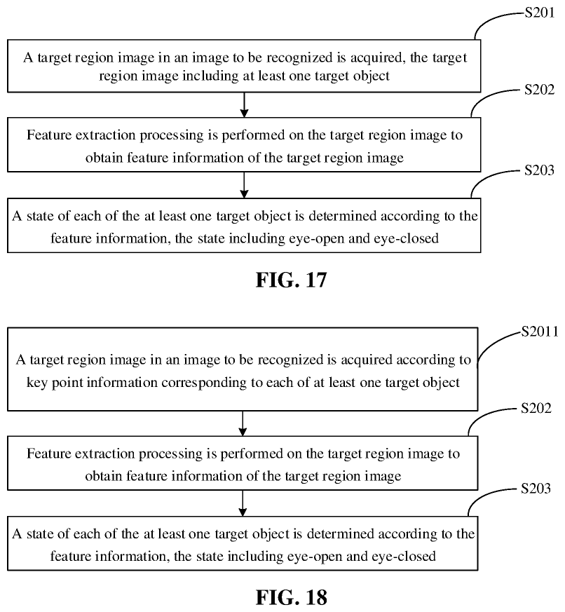

FIG. 17 is a flowchart of another method for image processing according to embodiments of the disclosure. The method may be applied to an electronic device or a system. The electronic device may be provided as a terminal, a server or a device of another form, for example, a mobile phone, a tablet computer or the like. As shown in FIG. 17, the method includes the following operations. In S201, A target region image in an image to be recognized is acquired, the target region image including at least one target object. In S202, feature extraction processing is performed on the target region image to obtain feature information of the target region image. In S203, a state of each of the at least one target object is determined according to the feature information, the state including eye-open and eye-closed.

According to the embodiments of the disclosure, the target region image in the image to be recognized may be acquired, the target region image including the at least one target object, feature extraction processing may be performed on the target region image to obtain the feature information of the target region image, and the state of each of the at least one target object may be determined according to the feature information, the state including eye-open and eye-closed. Therefore, the state of each of the at least one target object may be determined relatively accurately for identity authentication. For example, it may be determined that the state of the target object is eye-open or eye-closed. In some embodiments, recognition processing may be performed on the target region image to obtain the state of each of the at least one target object. For example, recognition processing may be performed on the target region image by use of a state recognition neural network to obtain state information of the at least one target object, the state information being configured to indicate the state of each of the at least one target object. The state recognition neural network may be trained according to a training sample set. For example, the state information may include an eye-open confidence or an eye-closed confidence, or may include an identifier indicating the state or an indicator indicating the state. A manner for determining the state information of the at least one target object, an information content and type of the state information and the like are not limited in the disclosure. In some embodiments, the at least one target object includes at least one eye. In some embodiments, the at least one target object may include two eyes, and correspondingly, the target region image may be a region image including two eyes. For example, the target region image may be a face image or two region images of which each includes an eye, i.e., a left-eye region image and a right-eye region image. No limits are made thereto in the embodiments of the disclosure. In some embodiments, feature extraction processing may be performed on the target region image to obtain feature information of the target region image, and the state of each of the at least one target object in the target region image may be determined based on the feature information of the target region image. In some embodiments, the electronic device may be any device such as a mobile phone, a pad, a computer, a server and the like. Descriptions are now made with the condition that the electronic device is a mobile phone as an example. For example, the mobile phone of the user may acquire the target region image in the image to be recognized, the target region image including the at least one target object. For example, as mentioned above, the target region image, acquired by the mobile phone of the user, in the image to be recognized may include a first region image and a second region image. The mobile phone of the user performs feature extraction processing on the target region image to obtain the feature information of the target region image. For example, as mentioned above, the mobile phone of the user may perform feature extraction processing on the target region image in multiple manners to obtain the feature information of the target region image. The mobile phone of the user determines the state of each of the at least one target object according to the feature information, the state including eye-open and eye-closed. Descriptions are made above, and elaborations are omitted herein.

FIG. 18 is another flowchart of another method for image processing according to embodiments of the disclosure. In some embodiments, as shown in FIG. 18, S201 may include the following operation. In S2011, the target region image in the image to be recognized is acquired according to key point information corresponding to each of the at least one target object. For example, a key point positioning network configured to position face key points may be trained by deep learning (for example, the key point positioning network may include a convolutional neural network). The key point positioning network may determine the key point information corresponding to each of the at least one target object in the image to be recognized to determine a region where each of the at least one target object is located. For example, the key point positioning network may determine key point information of each of the at least one eye in the image to be recognized (for example, the face image) and determine a position of contour points of the at least one eye. The mobile phone of the user may acquire the target region image in the image to be recognized, for example, acquiring the image(s) nearby the at least one eye, in multiple manners. Descriptions are made above, and elaborations are omitted herein. In such a manner, the target region image is acquired according to the key point information corresponding to each of the at least one target object, so that the target region image may be acquired rapidly and accurately, the target region image including the at least one target object. A manner for determining the key point information corresponding to each of the at least one target object and a manner for acquiring the target region image in the image to be recognized according to the key point information are not limited in the embodiment of the disclosure.

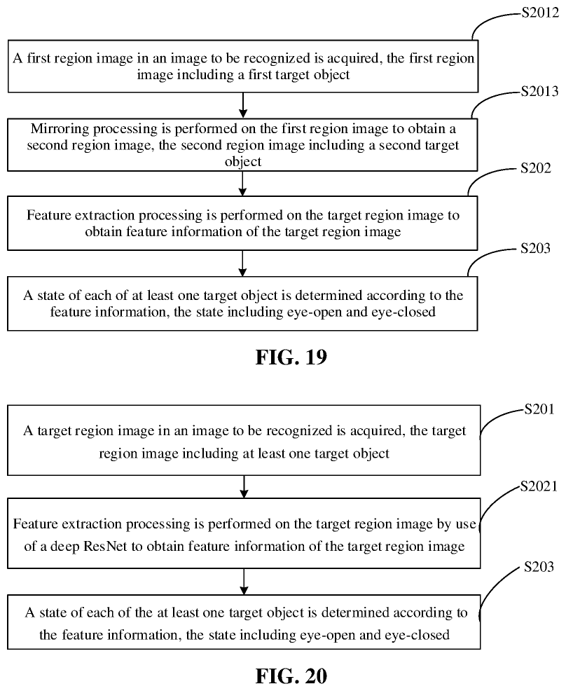

FIG. 19 is another flowchart of another method for image processing according to embodiments of the disclosure. In some embodiments, the target region image includes a first region image and a second region image, and the at least one target object includes a first target object and a second target object. As shown in FIG. 19, S201 may include the following steps.

In S2012, the first region image in the image to be recognized is acquired, the first region image including the first target object.

In S2013, mirroring processing is performed on the first region image to obtain the second region image, the second region image including the second target object.

For example, the mobile phone of the user may acquire the first region image in the image to be recognized in multiple manners, for example, according to the key point information corresponding to the first target object. The mobile phone of the user may perform mirroring processing on the first region image to obtain the second region image, the second region image including the second target object. Descriptions are made above, and elaborations are omitted herein. Therefore, the first region image and second region image in the target region image may be acquired relatively rapidly. It is to be understood that, when the target region image includes the first region image and the second region image, the operation that the target region image in the image to be recognized is acquired may also be implemented in a manner that the first region image and the second region image are acquired according to the key point information corresponding to the first target object and the key point information corresponding to the second target object respectively. The manner for acquiring the target region image in the image to be recognized, the number of region images in the target region image and the like are not limited in the embodiment of the disclosure.

FIG. 20 is another flowchart of another method for image processing according to embodiments of the disclosure. In some embodiments, as shown in FIG. 20, S202 may include the following operation.

In S2021, feature extraction processing is performed on the target region image by use of a deep ResNet to obtain the feature information of the target region image. For example, feature extraction processing may be performed on the target region image by use of the deep ResNet to obtain the feature information of the target region image. Descriptions are made above, and elaborations are omitted herein. In such a manner, the feature information of the target region image may be obtained relatively accurately by use of the deep ResNet. It is to be understood that feature extraction processing may be performed on the target region image by use of any convolutional neural network structure to obtain the feature information of the target region image and no limits are made thereto in the embodiment of the disclosure.

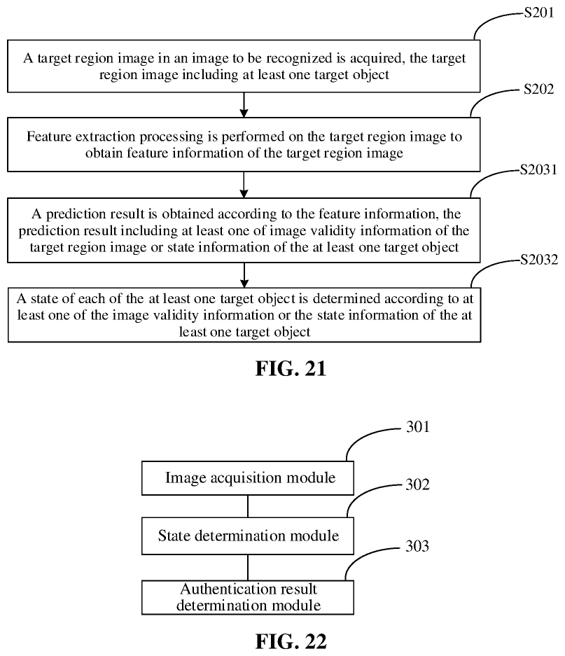

FIG. 21 is another flowchart of another method for image processing according to embodiments of the disclosure. In some embodiments, as shown in FIG. 21, S203 may include the following operations. In S2031, a prediction result is obtained according to the feature information, the prediction result including at least one of image validity information of the target region image or state information of the at least one target object. In S2032, the state of each of the at least one target object is determined according to at least one of the image validity information or the state information of the at least one target object. In some embodiments, the image validity information of the target region image may be determined based on the feature information of the target region image, and the state of the each of at least one target object may be determined based on the image validity information of the target region image. For example, the feature information of the target region image may be acquired. For example, feature extraction may be performed on the target region image through the trained neural network to obtain the feature information of the target region image, and the image validity information of the target region image may be determined according to the feature information of the target region image. For example, the feature information of the target region image is processed, for example, the feature information of the target region image is input to a fully connected layer of the neural network to obtain the image validity information of the target region image, and the state of each of the at least one target object is determined based on the image validity information of the target region image. Both a manner for determining the feature information of the target region image and a manner for determining the image validity information of the target region image and determining the state of each of the at least one target object based on the image validity information of the target region image are not limited in the disclosure.

For example, the mobile phone of the user may obtain the prediction result according to the feature information, the prediction result including at least one of the image validity information of the target region image or the state information of the at least one target object. The mobile phone of the user may determine the state of each of the at least one target object according to at least one of the image validity information and the state information of the at least one target object. Descriptions are made above, and elaborations are omitted herein. Therefore, the state of each of the at least one target object may be determined in multiple manners. A manner for determining the state of each of the at least one target object according to the prediction result is not limited in the disclosure. In some embodiments, the operation that the state of each of the at least one target object is determined according to at least one of the image validity information or the state information of the at least one target object (S2032) may include that: responsive to the image validity information indicating that the target region image is invalid, it is determined that the state of each of the at least one target object is eye-closed.

In some embodiments, the operation that the state of each of the at least one target object is determined according to at least one of the image validity information or the state information of the at least one target object (S2032) may include that: responsive to the image validity information indicating that the target region image is valid, the state of each of the at least one target object is determined based on the state information of each of the at least one target object. For example, as mentioned above, responsive to the prediction result acquired by the mobile phone of the user including the image validity information and the image validity information indicating that the target region image is invalid, it may be determined that the state of each of the at least one target object is eye-closed.

In some embodiments, the image validity information may include a validity confidence, and the validity confidence is information configured to indicate a probability that the image validity information is valid. For example, a first threshold configured to judge whether a target region image is valid or invalid may be preset. For example, when the validity confidence in the image validity information is lower than the first threshold, it may be determined that the target region image is invalid, and when the target region image is invalid, it may be determined that the state of each of the at least one target object is eye-closed. In such a manner, the state of each of the at least one target object may be determined rapidly and effectively. A manner for determining that the image validity information indicates that the target region image is invalid is not limited in the disclosure.

In some embodiments, the operation that the state of each of the at least one target object is determined according to at least one of the image validity information and the state information of the at least one target object (S2032) may include that: responsive to the validity confidence exceeding the first threshold and the eye-open confidence of the target object exceeding a second threshold, it is determined that the state of the target object is eye-open. For example, as mentioned above, the second threshold configured to judge that the state of each of the at least one target object is eye-open or eye-closed may be preset. For example, when the eye-open confidence(s) in the state information exceeds the second threshold, it may be determined that the state(s) of the at least one target object is/are eye-open, and when the eye-open confidence(s) in the state information is/are lower than the second threshold, it may be determined that the state(s) of the at least one target object is/are eye-closed. Under the condition that the validity confidence in the image validity information in the prediction result exceeds the first threshold (in such case, the image validity information indicates that the target region image is valid) and the eye-open confidence(s) of the target object(s) exceeds the second threshold (in such case, the state information indicates that the state(s) of the at least one target object is/are eye-open), the mobile phone of the user may determine that the state(s) of the target object is/are eye-open. In such a manner, the state(s) of the at least one target object may be determined relatively accurately to judge whether the user knows identity authentication. It is to be understood that the first threshold and the second threshold may be set by the system. A determination manner for the first threshold and the second threshold and specific numerical values of the first threshold and the second threshold are not limited in the disclosure.

It is to be understood that the method for image processing shown in FIGS. 17 to 21 may be implemented through any abovementioned image processing network, but no limits are made thereto in the embodiment of the disclosure.

FIG. 22 is an exemplary block diagram of an apparatus for image processing according to embodiments of the disclosure. The apparatus for image processing may be provided as a terminal (for example, a mobile phone, a pad, a computer and the like), a server or a device of another form. As shown in FIG. 22, the apparatus includes: an image acquisition module 301, configured to acquire a target region image in an image to be recognized, the target region image including at least one target object; a state determination module 302, configured to determine a state of each of the at least one target object based on the target region image, the state including eye-open and eye-closed; and an authentication result determination module 303, configured to determine an identity authentication result based at least part on the state of each of the at least one target object.

In some embodiments, the at least one target object includes at least one eye.

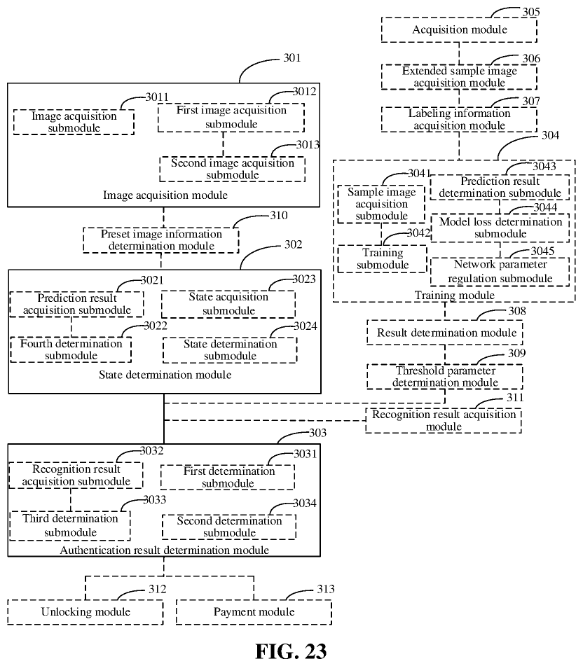

FIG. 23 is another exemplary block diagram of an apparatus for image processing according to embodiments of the disclosure. As shown in FIG. 23, in some embodiments, the authentication result determination module 303 includes a first determination submodule 3031, configured to, responsive to the at least one target object including a target object of which the state is eye-open, determine that identity authentication succeeds, or, under the condition that the at least one target object includes a target object of which the state is eye-open, determine that identity authentication succeeds.

As shown in FIG. 23, in some embodiments, the apparatus further includes a preset image information determination module 310, configured to, before the state of each of the at least one target object is determined based on the target region image, determine whether there is preset image information in a base database matched with the image to be recognized; and the state determination module 302 includes a state determination submodule 3024, configured to, responsive to there being the preset image information in a base database matched with the image to be recognized, determine the state of each of the at least one target object.

As shown in FIG. 23, in some embodiments, the apparatus further includes a recognition result acquisition module 311, configured to perform face recognition on the image to be recognized to obtain a face recognition result; and the authentication result determination module 303 includes a second determination submodule 3034, configured to determine the identity authentication result based at least part on the face recognition result and the state of each of the at least one target object. As shown in FIG. 23, in some embodiments, the authentication result determination module 303 includes: a recognition result acquisition submodule 3032, configured to, responsive to the at least one target object including the target object of which the state is eye-open, perform face recognition on the image to be recognized to obtain the face recognition result; and a third determination submodule 3033, configured to determine the identity authentication result based on the face recognition result.

As shown in FIG. 23, in some embodiments, the image acquisition module 301 includes an image acquisition submodule 3011, configured to acquire the target region image in the image to be recognized according to key point information corresponding to each of the at least one target object. As shown in FIG. 23, in some embodiments, the target region image includes a first region image and a second region image, and the at least one target object includes a first target object and a second target object; and the image acquisition module 301 includes: a first image acquisition submodule 3012, configured to acquire the first region image in the image to be recognized, the first region image including the first target object, and a second image acquisition submodule 3013, configured to perform mirroring processing on the first region image to obtain the second region image, the second region image including the second target object. As shown in FIG. 23, in some embodiments, the state determination module 302 includes: a prediction result acquisition submodule 3021, configured to process the target region image to obtain a prediction result, the prediction result including at least one of image validity information of the target region image or state information of the at least one target object; and a fourth determination submodule 3022, configured to determine the state of each of the at least one target object according to at least one of the image validity information or the state information of the at least one target object.

In some embodiments, the fourth determination submodule 3022 includes an eye-closed determination submodule, configured to, responsive to the image validity information indicating that the target region image is invalid, determine that the state of each of the at least one target object is eye-closed. In some embodiments, the fourth determination submodule 3022 includes a first object state determination submodule, configured to, responsive to the image validity information indicating that the target region image is valid, determine the state of each of the at least one target object based on the state information of each of the at least one target object.

In some embodiments, the image validity information includes a validity confidence, and the state information includes an eye-open confidence; and the fourth determination submodule 3022 includes an eye-open determination submodule, configured to, responsive to the validity confidence exceeding a first threshold and the eye-open confidence of the target object exceeding a second threshold, determine that the state of the target object is eye-open. In some embodiments, the prediction result acquisition submodule 3021 includes: a feature information acquisition submodule, configured to perform feature extraction processing on the target region image to obtain feature information of the target region image; and a result acquisition submodule, configured to obtain the prediction result according to the feature information. In some embodiments, the feature information acquisition submodule includes an information acquisition submodule, configured to perform feature extraction processing on the target region image by use of a deep ResNet to obtain the feature information of the target region image.

As shown in FIG. 23, in some embodiments, the apparatus further includes an unlocking module 312, configured to, responsive to determining that identity authentication succeeds, unlock a terminal device. As shown in FIG. 23, in some embodiments, the apparatus further includes a payment module 313, configured to, responsive to determining that identity authentication succeeds, execute a payment operation.

As shown in FIG. 23, in some embodiments, the state determination module 302 includes a state acquisition submodule 3023, configured to process the target region image by use of an image processing network to obtain the state of each of the at least one target object; and the apparatus further includes a training module 304, configured to train the image processing network according to multiple sample images. As shown in FIG. 23, in some embodiments, the training module 304 includes: a sample image acquisition submodule 3041, configured to preprocess the multiple sample images to obtain multiple preprocessed sample images; and a training submodule 3042, configured to train the image processing network according to the multiple preprocessed sample images.

As shown in FIG. 23, in some embodiments, the training module 304 includes: a prediction result determination submodule 3043, configured to input the sample image to the image processing network for processing to obtain a prediction result corresponding to the sample image; a model loss determination submodule 3044, configured to determine model loss of the image processing network according to the prediction result and labeling information corresponding to the sample image; and a network parameter regulation submodule 3045, configured to regulate a network parameter value of the image processing network according to the model loss.

As shown in FIG. 23, in some embodiments, the apparatus further includes: an acquisition module 305, configured to acquire multiple initial sample images and labeling information of the multiple initial sample images; an extended sample image acquisition module 306, configured to perform conversion processing on at least one initial sample image in the multiple initial sample images to obtain at least one extended sample image, conversion processing including at least one of occluding, image exposure changing, image contrast changing or transparentizing processing; and a labeling information acquisition module 307, configured to obtain labeling information of the at least one extended sample image based on conversion processing executed on the at least one initial sample image and the labeling information of the at least one initial sample image, the multiple sample images including the multiple initial sample images and the at least one extended sample image. As shown in FIG. 23, in some embodiments, the apparatus further includes: a result determination module 308, configured to process a test sample by use of the image processing network to obtain a prediction result of the test sample; and a threshold parameter determination module 309, configured to determine a threshold parameter of the image processing network based on the prediction result of the test sample and labeling information of the test sample.

In some embodiments, besides the components shown in FIG. 22, the apparatus may further include the acquisition module, the extended sample image acquisition module, the labeling information acquisition module and a network training module.

The acquisition module is configured to acquire the multiple initial sample images and the labeling information of the multiple initial sample images.

The extended sample image acquisition module is configured to perform conversion processing on the at least one initial sample image in the multiple initial sample images to obtain the at least one extended sample image, conversion processing including at least one of occluding, image exposure changing, image contrast changing or transparentizing processing.

The labeling information acquisition module is configured to obtain the labeling information of the at least one extended sample image based on conversion processing executed on the at least one initial sample image and the labeling information of the at least one initial sample image.

The network training module is configured to train the image processing network based on a training sample set including the multiple initial sample images and the at least one extended sample image.

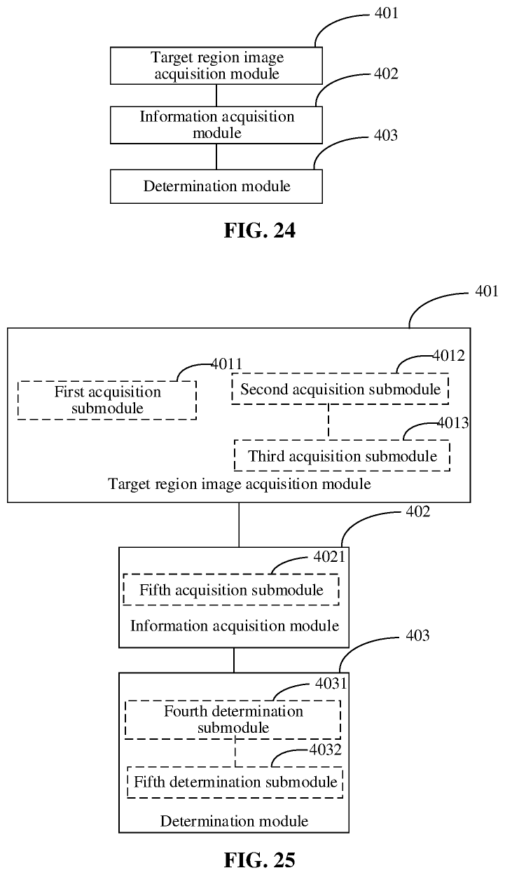

FIG. 24 is an exemplary block diagram of another apparatus for image processing according to embodiments of the disclosure. The apparatus for image processing be provided as a terminal (for example, a mobile phone, a pad and the like), a server or a device of another form. As shown in FIG. 24, the apparatus includes: a target region image acquisition module 401, configured to acquire a target region image in an image to be recognized, the target region image including at least one target object; an information acquisition module 402, configured to perform feature extraction processing on the target region image to obtain feature information of the target region image; and a determination module 403, configured to determine a state of each of the at least one target object according to the feature information, the state including eye-open and eye-closed.

FIG. 25 is another exemplary block diagram of another apparatus for image processing according to embodiments of the disclosure. As shown in FIG. 25, in some embodiments, the target region image acquisition module 401 includes a first acquisition submodule 4011, configured to acquire the target region image in the image to be recognized according to key point information corresponding to each of the at least one target object.

As shown in FIG. 25, in some embodiments, the target region image includes a first region image and a second region image, and the at least one target object includes a first target object and a second target object; and the target region acquisition module 401 includes: a second acquisition submodule 4012, configured to acquire the first region image in the image to be recognized, the first region image including the first target object, and a third acquisition submodule 4013, configured to perform mirroring processing on the first region image to obtain the second region image, the second region image including the second target object.

As shown in FIG. 25, in some embodiments, the determination module 403 includes: a fourth acquisition submodule 4031, configured to obtain a prediction result according to the feature information, the prediction result including at least one of image validity information of the target region image or state information of the at least one target object; and a fifth determination submodule 4032, configured to determine the state of each of the at least one target object according to at least one of the image validity information or the state information of the at least one target object. In some embodiments, the fifth determination submodule 4032 includes a sixth determination submodule, configured to, responsive to the image validity information indicating that the target region image is invalid, determine that the state of each of the at least one target object is eye-closed.

In some embodiments, the fifth determination submodule 4032 includes a second object state determination submodule, configured to, responsive to the image validity information indicating that the target region image is valid, determine the state of each of the at least one target object based on the state information of each of the at least one target object. In some embodiments, the image validity information includes a validity confidence, and the state information includes an eye-open confidence.

The fifth determination module 4032 includes a seventh determination submodule, configured to, responsive to the validity confidence exceeding a first threshold and the eye-open confidence of the target object exceeding a second threshold, determine that the state of the target object is eye-open. As shown in FIG. 25, in some embodiments, the information acquisition submodule 402 includes a fifth acquisition submodule 4021, configured to perform feature extraction processing on the target region image by use of a deep ResNet to obtain the feature information of the target region image.

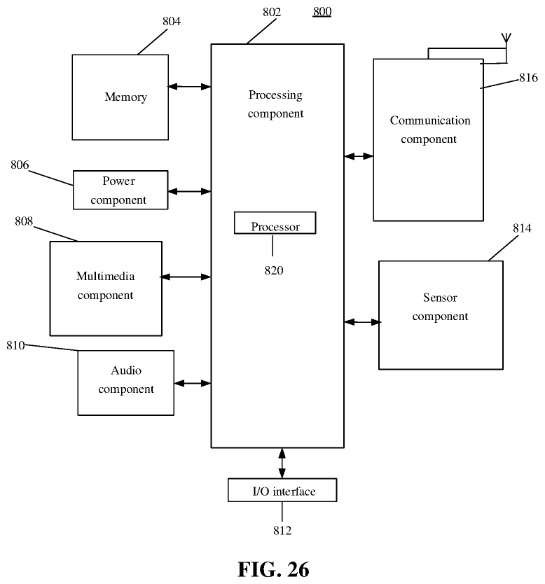

FIG. 26 is an exemplary block diagram of an electronic device according to embodiments of the disclosure. For example, the electronic device 800 may be a terminal such as a mobile phone, a computer, a digital broadcast terminal, a messaging device, a gaming console, a tablet, a medical device, exercise equipment, a personal digital assistant and the like. Referring to FIG. 26, the electronic device 800 may include one or more of the following components: a processing component 802, a memory 804, a power component 806, a multimedia component 808, an audio component 810, an Input/Output (I/O) interface 812, a sensor component 814, and a communication component 816. The processing component 802 typically controls overall operations of the electronic device 800, such as the operations associated with display, telephone calls, data communications, camera operations, and recording operations. The processing component 802 may include one or more processors 820 to execute instructions to perform all or part of the steps in the abovementioned method. Moreover, the processing component 802 may include one or more modules which facilitate interaction between the processing component 802 and the other components. For instance, the processing component 802 may include a multimedia module to facilitate interaction between the multimedia component 808 and the processing component 802. The memory 804 is configured to store various types of data to support the operation of the electronic device 800. Examples of such data include instructions for any application programs or methods operated on the electronic device 800, contact data, phonebook data, messages, pictures, video, etc. The memory 804 may be implemented by a volatile or nonvolatile storage device of any type or a combination thereof, for example, a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or an optical disk. The power component 806 provides power for various components of the electronic device 800. The power component 806 may include a power management system, one or more power supplies, and other components associated with generation, management and distribution of power for the electronic device 800. The multimedia component 808 includes a screen providing an output interface between the electronic device 800 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. The touch sensors may not only sense a boundary of a touch or swipe action but also detect a duration and pressure associated with the touch or swipe action. The front camera and/or the rear camera may receive external multimedia data when the electronic device 800 is in an operation mode, such as a photographing mode or a video mode. Each of the front camera and the rear camera may be a fixed optical lens system or have focusing and optical zooming capabilities. The audio component 810 is configured to output and/or input an audio signal. For example, the audio component 810 includes a Microphone (MIC), and the MIC is configured to receive an external audio signal when the electronic device 800 is in the operation mode, such as a call mode, a recording mode and a voice recognition mode. The received audio signal may further be stored in the memory 804 or sent through the communication component 816. In some embodiments, the audio component 810 further includes a speaker configured to output the audio signal. The I/O interface 812 provides an interface between the processing component 802 and a peripheral interface module, and the peripheral interface module may be a keyboard, a click wheel, buttons and the like. The buttons may include, but not limited to: a home button, a volume button, a starting button and a locking button. The sensor component 814 includes one or more sensors configured to provide status assessment in various aspects for the electronic device 800. For instance, the sensor component 814 may detect an on/off status of the electronic device 800 and relative positioning of components, such as a display and small keyboard of the electronic device 800, and the sensor component 814 may further detect a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 may include a proximity sensor configured to detect presence of an object nearby without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device 800 and another device. The electronic device 800 may access a communication-standard-based wireless network, such as a Wireless Fidelity (WiFi) network, a 2nd-Generation (2G) or 3rd-Generation (3G) network or a combination thereof. In an exemplary embodiment, the communication component 816 receives a broadcast signal or broadcast associated information from an external broadcast management system through a broadcast channel In an exemplary embodiment, the communication component 816 further includes a Near Field Communication (NFC) module to facilitate short-range communication. For example, the NFC module may be implemented based on a Radio Frequency Identification (RFID) technology, an Infrared Data Association (IrDA) technology, an Ultra-Wide Band (UWB) technology, a Bluetooth (BT) technology and another technology. Exemplarily, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method. Exemplarily, a nonvolatile computer-readable storage medium is also provided, for example, a memory 804 including computer program instructions. The computer program instructions may be executed by a processor 820 of an electronic device 800 to implement the abovementioned method.

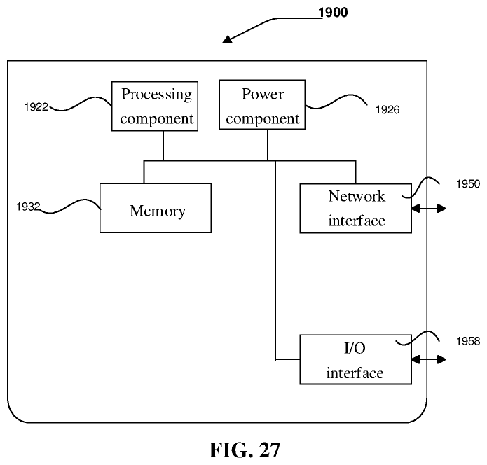

FIG. 27 is another exemplary block diagram of an electronic device according to embodiments of the disclosure. For example, the electronic device 1900 may be provided as a server. Referring to FIG. 27, the electronic device 1900 includes a processing component 1922, further including one or more processors, and a memory resource represented by a memory 1932, configured to store instructions executable for the processing component 1922, for example, an application program. The application program stored in the memory 1932 may include one or more modules of which each corresponds to a set of instructions. In addition, the processing component 1922 is configured to execute the instructions to execute the abovementioned method. The electronic device 1900 may further include a power component 1926 configured to execute power management of the electronic device 1900, a wired or wireless network interface 1950 configured to connect the electronic device 1900 to a network and an I/O interface 1958. The electronic device 1900 may be operated based on an operating system stored in the memory 1932, for example, Windows Server™, Mac OS X™, Unix™, Linux™, FreeBSD™ or the like. Exemplarily, a nonvolatile computer-readable storage medium is also provided, for example, a memory 1932 including computer program instructions. The computer program instructions may be executed by a processing component 1922 of an electronic device 1900 to implement the abovementioned method. The disclosure may be a system, a method and/or a computer program product. The computer program product may include a computer-readable storage medium, in which a computer-readable program instruction configured to enable a processor to implement each aspect of the disclosure is stored. The computer-readable storage medium may be a physical device capable of retaining and storing instructions used by an instruction execution device. For example, the computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a ROM, an EPROM (or a flash memory), an SRAM, a Compact Disc Read-Only Memory (CD-ROM), a Digital Video Disk (DVD), a memory stick, a floppy disk, a mechanical coding device, a punched card or in-slot raised structure with an instruction stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instructions described here may be downloaded from the computer-readable storage medium to each computing/processing device or downloaded to an external computer or an external storage device through a network. A network adapter card or network interface in each computing/processing device receives the computer-readable program instruction from the network and forwards the computer-readable program instruction for storage in the computer-readable storage medium in each computing/processing device.

The computer program instructions configured to execute the operations of the disclosure may be assembly instructions, Instruction Set Architecture (ISA) instructions, machine instructions, machine related instructions, microcodes, firmware instructions, state setting data or a source code or target code edited by one or any combination of more programming languages, the programming languages including an object-oriented programming language such as Smalltalk and C++ and a conventional procedural programming language such as “C” language or a similar programming language. The computer-readable program instructions may be completely or partially executed in a computer of a user, executed as an independent software package, executed partially in the computer of the user and partially in a remote computer, or executed completely in the remote server or a server. Herein, each aspect of the disclosure is described with reference to flowcharts and/or block diagrams of the method, device (system) and computer program product according to the embodiments of the disclosure. It is to be understood that each block in the flowcharts and/or the block diagrams and a combination of each block in the flowcharts and/or the block diagrams may be implemented by computer-readable program instructions.

These computer-readable program instructions may be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner, so that the computer-readable medium including the instructions includes a product including instructions for implementing each aspect of the function/action specified in one or more blocks in the flowcharts and/or the block diagrams.

These computer-readable program instructions may further be loaded to the computer, the other programmable data processing device or the other device, so that a series of operating operations are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

It is to be understood that the method for image processing shown in FIGS. 17 to 21 may be implemented through any abovementioned image processing network, but no limits are made thereto in the embodiment of the disclosure.

The flowcharts and block diagrams in the drawings illustrate probably implemented system architectures, functions and operations of the system, method and computer program product according to multiple embodiments of the disclosure. On this aspect, each block in the flowcharts or the block diagrams may represent part of a module, a program segment or an instruction, and part of the module, the program segment or the instruction includes one or more executable instructions configured to realize a specified logical function. In some alternative implementations, the functions marked in the blocks may also be realized in a sequence different from those marked in the drawings. For example, two continuous blocks may actually be executed substantially concurrently and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and computer instructions.

Each embodiment of the disclosure has been described above. The above descriptions are exemplary, non-exhaustive and also not limited to each disclosed embodiment. Many modifications and variations are apparent to those of ordinary skill in the art without departing from the scope and spirit of each described embodiment of the disclosure. The terms used herein are selected to explain the principle and practical application of each embodiment or technical improvements in the technologies in the market best or enable others of ordinary skill in the art to understand each embodiment disclosed herein.

1. A method for image processing, comprising:
acquiring a target region image in an image to be recognized, the target region image comprising at least one target object;
determining, based on the target region image, a state of each of the at least one target object, the state comprising eye-open and eye-closed; and
determining, based at least part on the state of each of the at least one target object, an identity authentication result.

2. The method of claim 1, wherein the at least one target object comprises at least one eye.

3. The method of claim 1, wherein determining, based at least part on the state of each of the at least one target object, the identity authentication result comprises:
responsive to the at least one target object comprising a target object of which the state is eye-open, determining that identity authentication succeeds.

4. The method of claim 1, before determining, based on the target region image, the state of each of the at least one target object, further comprising: determining whether there is preset image information in a base database matched with the image to be recognized, wherein
determining, based on the target region image, the state of each of the at least one target object comprises: responsive to there being the preset image information in the base database matched with the image to be recognized, determining the state of each of the at least one target object.

5. The method of claim 1, further comprising: performing face recognition on the image to be recognized to obtain a face recognition result, wherein
determining, based at least part on the state of each of the at least one target object, the identity authentication result comprises: determining, based at least part on the face recognition result and the state of each of the at least one target object, the identity authentication result.

6. The method of claim 1, wherein determining, based at least part on the state of each of the at least one target object, the identity authentication result comprises:
responsive to determining the at least one target object comprising the target object of which the state is eye-open, performing face recognition on the image to be recognized to obtain a the face recognition result; and
determining, based on the face recognition result, the identity authentication result.

7. (canceled)

8. The method of claim 1, wherein the target region image comprise a first region image and a second region image, and the at least one target object comprises a first target object and a second target object; and
acquiring the target region image in the image to be recognized comprises:
acquiring the first region image in the image to be recognized, the first region image comprising the first target object, and
performing mirroring processing on the first region image to obtain the second region image, the second region image comprising the second target object.

9. The method of claim 1, wherein determining, based on the target region image, the state of each of the at least one target object comprises:
processing the target region image to obtain a prediction result, the prediction result comprising at least one of: image validity information of the target region image, or state information of the at least one target object; and
determining, according to at least one of the image validity information or the state information of the at least one target object, the state of each of the at least one target object.

10. The method of claim 9, wherein determining, according to at least one of the image validity information or the state information of the at least one target object, the state of each of the at least one target object comprises at least one of the following:
responsive to the image validity information indicating that the target region image is invalid, determining that the state of each of the at least one target object is eye-closed; or,
responsive to the image validity information indicating that the target region image is valid, determining, based on the state information of each of the at least one target object, the state of each of the at least one target object.

11. The method of claim 9, wherein the image validity information comprises a validity confidence, and the state information comprises an eye-open confidence; and
determining, according to at least one of the image validity information or the state information of the at least one target object, the state of each of the at least one target object comprises: responsive to the validity confidence exceeding a first threshold and the eye-open confidence of the target object exceeding a second threshold, determining that the state of the target object is eye-open.

12. The method of claim 9, wherein processing the target region image to obtain the prediction result comprises:
performing feature extraction processing on the target region image to obtain feature information of the target region image; and
obtaining, according to the feature information of the target region image, the prediction result of the target region image.

13. (canceled)

14. The method of claim 1, further comprising: responsive to determining that identity authentication succeeds, unlocking a terminal device; or
responsive to determining that identity authentication succeeds, executing a payment operation.

15.-17. (canceled)

18. A method for image processing, comprising:
acquiring a target region image in an image to be recognized, the target region image comprising at least one target object;
performing feature extraction processing on the target region image to obtain feature information of the target region image; and
determining, according to the feature information of the target region image, a state of each of the at least one target object, the state comprising eye-open and eye-closed.

19. The method of claim 18, wherein acquiring the target region image in the image to be recognized comprises:
acquiring, according to key point information corresponding to each of the at least one target object, the target region image in the image to be recognized.

20. The method of claim 18, wherein the target region image comprise a first region image and a second region image, and the at least one target object comprises a first target object and a second target object; and
acquiring the target region image in the image to be recognized comprises:
acquiring the first region image in the image to be recognized, the first region image comprising the first target object, and
performing mirroring processing on the first region image to obtain the second region image, the second region image comprising the second target object.

21. The method of claim 18, wherein determining, according to the feature information of the target region image, the state of each of the at least one target object comprises:
obtaining, according to the feature information of the target region image, a prediction result, the prediction result comprising at least one of image validity information of the target region image or state information of the at least one target object; and
determining, according to at least one of the image validity information or the state information of the at least one target object, the state of each of the at least one target object.

22. The method of claim 21, wherein determining, according to at least one of the image validity information or the state information of the at least one target object, the state of each of the at least one target object comprises at least one of the following:
responsive to the image validity information indicating that the target region image is invalid, determining that the state of each of the at least one target object is eye-closed; or,
responsive to the image validity information indicating that the target region image is valid, determining, based on the state information of each of the at least one target object, the state of each of the at least one target object.

23. The method of claim 21, wherein the image validity information comprises a validity confidence, and the state information comprises an eye-open confidence; and
determining, according to at least one of the image validity information or the state information of the at least one target object, the state of the at least one target object comprises: responsive to the validity confidence exceeding a first threshold and the eye-open confidence of the target object exceeding a second threshold, determining that the state of the target object is eye-open.

24.-48. (canceled)

49. An electronic device, comprising:
a processor;
a memory, configured to store instructions executable for the processor, wherein the processor is configured to call the instructions stored in the memory to execute:
acquiring a target region image in an image to be recognized, the target region image comprising at least one target object;
determining, based on the target region image, a state of each of the at least one target object, the state comprising eye-open and eye-closed; and
determining, based at least part on the state of each of the at least one target object, an identity authentication result.

50. A computer-readable storage medium, in which computer program instructions are stored, the computer program instructions being executed by a processor to implement the method of claim 1.

51. (canceled)
